(19) United States
(12) Patent Application Publication
(10) Pub. No.: US 2025/0355682 A1
(43) Pub. Date: Nov. 20, 2025

(54) SYSTEM(S) AND METHOD(S) FOR PROVIDING A GENERATIVE CONTENT GRAPHICAL CARD AT CLIENT DEVICE(S)

(71) Applicant: GOOGLE LLC, Mountain View, CA (US)

(72) Inventors: Annekathrin Arndt Tihhonov, Zurich (CH); Sergey Nazarov, Kilchberg (CH); Kinda Akash, Oakland, CA (US); Maryam Karimzadehgan, Portola Valley, CA (US); Olivier Lacombe, San Francisco, CA (US); Bhavana Motwani, Bengaluru (IN); Zaheed Sabur, Baar (CH)

(21) Appl. No.: 19/055,205

(22) Filed: Feb. 17, 2025

(30) Foreign Application Priority Data
May 14, 2024 (IN) IN202411037716

(51) Int. Cl. G06F 9/451; G06F 3/04842

(52) U.S. Cl. CPC G06F 9/451; G06F 3/04842

(57) ABSTRACT

Implementations described herein relate to providing a generative content graphical card at client device(s) that enable user(s) of the client device(s) to interact with various generative model(s) (GM(s)). Processor(s) of a system can: receive an invocation of a generative content graphical card; and in response to receiving the invocation: causing the generative content graphical card to be visually rendered such that it overlays content displayed at the client device; process, using a GM, GM input (including at least the displayed content) to generate GM output; determine, based on the GM output, a plurality of suggestions that are each associated with a corresponding action; and cause the plurality of suggestions to be visually rendered. Further, the processor(s) can, in response to receiving a user selection of a given suggestion: cause the corresponding action to be performed; and cause a result of performance of the corresponding action to be visually rendered.

### BACKGROUND

Various generative model(s) (GM(s)) have been proposed that can be used to process user input(s), to generate output that reflects generative content that is responsive to the user input(s). For example, large language models (LLM(s)) have been developed that can be used to process user input(s), to generate LLM output that reflects text-based generative content that is responsive to the user input(s). Further, image and video generation model(s) have been developed that can be used to process user input(s), to generate image-based and/or video-based generative content that is responsive to the user input(s).

In many instances, user(s) must provide explicit user input(s) that are directed to these GM(s) to interact with these GM(s). For example, user(s) are typically required to access a particular web page and/or particular software application and, upon accessing a particular web page and/or particular software application, provide explicit user input(s) (e.g., typed or spoken) that are directed to these GM(s) and/or upload other content (e.g., document(s), image(s), video(s), etc.) that is to be processed by these GM(s). However, requiring user(s) to access a particular web page and/or particular software application unnecessarily wastes computational resources. For example, if a user desires to export responsive content that is generated using these GM(s) to another web page and/or another software application, additional user input(s) are typically required to, for instance, copy the responsive content in particular web page and/or particular software application, navigate to the other web page and/or other software application, then past the responsive content therein, thereby increasing a quantity of user input(s) received and prolonging a human-to-machine interaction.

Also, in many instances, context utilized in generating the responsive content is limited to prior user input(s) and/or prior responsive content that is generated responsive to the prior user input(s) and fails to consider any content that is displayed at client device(s) with user(s) utilize to interact with these GM(s). This problem is exacerbated when the user(s) are required to access a particular web page and/or particular software application to interact with these GM(s) since the content that is displayed at the client device(s) may be limited to content from the human-to-machine interaction. As a result, these GM(s) are generally not capable of extracting the content that is displayed at the client device(s). Additional and/or alternative drawbacks of these and/or other approaches may be presented.

### SUMMARY

Implementations described herein relate to providing a generative content graphical card at client device(s) that enable user(s) of the client device(s) to interact with various generative model(s) (GM(s)). Processor(s) of a system can: receive an invocation of a generative content graphical card; and in response to receiving the invocation: causing the generative content graphical card to be visually rendered such that it overlays content displayed at the client device; process, using a GM, GM input (including at least the displayed content) to generate GM output; determine, based on the GM output, a plurality of suggestions that are each associated with a corresponding action; and cause the plurality of suggestions to be visually rendered. Further, the processor(s) can, in response to receiving a user selection of a given suggestion: cause the corresponding action to be performed; and cause a result of performance of the corresponding action to be visually rendered. In various implementations, the user of the client device can invoke the generative content graphical card by speaking a particular word or phrase that invokes the generative content graphical card, by actuating a hardware button of the mobile device that invokes the generative content graphical card, by actuating a software button of the mobile device that invokes the generative content graphical card, and/or by other means.

For example, assume that a user of a mobile device (e.g., an instance of the client device) is viewing a document via files software application that is accessible at the mobile device. Further assume that the user of the client device invokes the generative content graphical card (e.g., by directing the particular word or phrase to the mobile device, by actuating a hardware button or software button of the mobile device, etc.). In this example, the processor(s) can cause the generative content graphical card to be visually rendered in such a manner that it overlays the document being viewed via the files software application, such that the generative content graphical card is in a forefront of the display of the mobile device, but the document (or portion(s) thereof) in viewable in the background of the display of the mobile device. Notably the generative content graphical card can overlay a bottom portion of the display of the mobile device, a side portion of the display of the mobile device, a top portion of the display of the mobile device, etc.

Further, and in response to receiving the invocation of the generative content graphical card, the processor(s) can process, using a GM, GM input to generate the GM output. Notably, the GM can be, for example, an on-device GM that is stored locally at the mobile device such as Gemini Nano or other GM(s) that are capable of being implemented locally at the mobile device. In this example, the GM input can include, for example, portion(s) of the document that are being viewed when the generative content graphical card is invoked (or feature(s) determined based on the portion(s) of the document that are being viewed when the generative content graphical card is invoked), the document in its entirety (or feature(s) determined based on the document in its entirety), additional data associated with the document such as metadata associated with the document (or feature(s) determined based on the additional data associated with the document). In various implementations, the user may be required to confirm that one or more of the aforementioned aspects of the document are to be included in the GM input. However, in other implementations, one or more of the aforementioned aspects of the document are to be automatically included in the GM input (e.g., without the explicit user confirmation). Notably, one or more of the aforementioned aspects of the document can also be stored in on-device memory of the client device at least throughout a duration of the interaction between the user and the generative content graphical card.

Further, the GM output can include, for example, a probability distribution over a sequence of tokens. The sequence of tokens can correspond to, for instance, candidate suggestions for actions that are performable with respect to the document that is being viewed at the mobile device and/or corresponding action parameters for the actions that are performable with respect to the document that is being viewed at the mobile device. Notably, the GM can fine-tuned to generate the sequence of tokens corresponding to the candidate suggestions based on fine-tuning the GM (e.g., using supervised fine-tuning (SFT) techniques, reinforcement learning from human feedback (RLHF) techniques, and/or other fine-tuning techniques) and/or based on the GM input additionally including zero-shot example(s) to generate the sequence of tokens corresponding to the candidate suggestions. Accordingly, the processor(s) can determine, based on the probability distribution, multiple of the candidate suggestions and, as a result, the corresponding actions and/or the corresponding actions associated the corresponding actions, to be rendered at the mobile device as the plurality of suggestions, and the processor(s) can cause the plurality of suggestions to be visually rendered at the mobile device along with the generative content graphical card. Some non-limiting examples of the plurality of suggestions that can be determined for the document in this example include: a summarization suggestion that, when selected, will cause the processor(s) to summarize the document being summarized for the user of the mobile device; a read aloud suggestion that, when selected, will cause the processor(s) to perform text-to-speech (TTS) on the document to audibly render the content of the document for presentation to the user via speaker(s) of the mobile device; an analytical suggestion that, when selected, will cause the processor(s) to generate, for example, one or more charts or other analytical operations based on data contained in the document; an electronic communications suggestion that, when selected, will cause the processor(s) to generate a draft electronic communication that includes the document and that can be forwarded to one or more recipient users, etc.

In various implementations, the corresponding actions associated with the plurality of suggestions can include generative action(s) that require utilization of the GM that is stored locally at the client device or an additional GM that is remote from the client device (e.g., stored at a remote system that is in network communication with the client device). Notably, the additional GM can be, for example, a cloud-based GM that is stored at a remote system such as Gemini Ultra or Gemini Pro or other GM(s) that have more parameters, but are more computationally intensive than on-device GMs. Continuing with the above example, the generative action(s) can be associated with, for instance, the summarization suggestion, the analytical suggestion, and the electronic communications suggestion since the corresponding actions associated with these suggestions require utilization of the GM or the additional GM. In additional or alternative implementations, the corresponding actions associated with the plurality of suggestions can include non-generative action(s) that do not require utilization of the GM that is stored locally at the client device or the additional GM that is remote from the client device. Continuing with the above example, the non-generative action(s) can be associated with, for instance, the read aloud suggestion since the corresponding action associated with this suggestion does not require utilization of the GM or the additional GM.

In various implementations, the plurality of suggestions can include dynamic suggestions that are specific to the content that is displayed at the client device. Continuing with the above example, the dynamic suggestions that are specific to the content that is displayed at the client device can include, for instance, the analytical suggestion since it is specific to data that is included in the document, and the electronic communications suggestion since it is specific to communicating the document that is being viewed to one or more recipient users. In additional or alternative implementations, the plurality of suggestions can include static suggestions that are not specific to the content that is displayed at the client device. Continuing with the above example, the static suggestions that are not specific to the content that is displayed at the client device can include, for instance, the summarization suggestion and the read aloud suggestion since any content that is displayed at the client device (or feature(s) determined based on the content that is displayed at the client device) can be summarized and/or read aloud to the user to explain to the user what is being viewed at the client device. In some implementations, the static suggestions that are not specific to the content that is displayed at the client device can be visually rendered along with the generative content graphical card and while the GM is being utilized to determine the dynamic suggestions such that the static suggestions and the dynamic suggestions are visually rendered in an asynchronous manner.

Moreover, and in response to receiving a user selection of a given suggestion, from among the plurality of suggestions, the processor(s) can cause the corresponding action to be performed; and cause a result of performance of the corresponding action to be visually rendered. As noted above, the plurality of suggestions that are visually rendered for presentation to the user can include generative action(s) that require utilization of the GM that is stored locally at the client device or the additional GM that is remote from the client device. In implementations where the corresponding action associated with given suggestion from the user selection is a generative action, the processor(s) can determine, based on one or more criteria, whether to utilize the GM that is stored locally at the client device or the additional GM that is remote from the client device in causing the corresponding action to be performed. The one or more criteria can include, for example, one or more of: whether the GM is capable of causing the corresponding action to be performed, whether the additional GM is capable of causing the corresponding action to be performed, whether the GM output specifies the GM or the additional GM should be utilized in causing the corresponding action to be performed, whether the client device has at least a threshold state of charge, weather a threshold quantity of computational resources are available at the client device to cause the corresponding action to be performed, a network connection status of the client device, hardware constraints of the client device, or software constraints of the client device. Put another way, the processor(s) can balance criteria related to capabilities of the GM relative to capabilities of the additional GM, dynamic hardware constraints of the client device (e.g., current battery level, current availability of computational resources at the client device, current availability of on-device memory of the client device, etc.), static hardware constraints of the client device (e.g., a type of processor(s) of the client device, a size of the on-device storage of the client device), and/or other criteria in determining whether to utilize the GM that is stored locally at the client device or the additional GM that is remote from the client device in causing the corresponding action to be performed.

In implementations where the GM that is stored locally at the client device is utilized in causing the corresponding action to be performed, the processor(s) can obtain the displayed content from the on-device memory of the client device; process, using the GM, additional GM input to generate additional GM output; and determine, based on the additional GM output, the result of the performance of the corresponding action. Notably, the additional GM input can include not only the displayed content that is obtained from the on-device memory of the client device, but also an indication of the corresponding action to be performed and/or an indication of one or more corresponding action parameters associated with the corresponding action to be performed. The indication of the corresponding action to be performed and/or the indication of one or more corresponding action parameters associated with the corresponding action to be performed can include, for example, structured commands for the GM to implement and in response to receiving the user selection. Continuing with the above example, assume that the user selection is directed to the electronic communications suggestion. In this example, the processor(s) can cause the GM make one or more application programming interface (API) calls to generate a draft email that is based on the document and that attaches the document such that the user only need to further specify the one or more recipients and hit send to cause the draft email to be transmitted to client device(s) associated with the one or more recipients. In this example, the result of the performance of the corresponding action is the draft email that is generated (and optionally opened in an email application of the mobile device).

In implementations where the additional GM that is remote from the client device is utilized in causing the corresponding action to be performed, the processor(s) can obtain the displayed content from the on-device memory of the client device; transmit, to the remote system, the displayed content that is obtained from the on-device memory of the client device and an indication of the corresponding action to be performed and/or an indication of one or more corresponding action parameters associated with the corresponding action to be performed; and receive, from the remote system, the result of the performance of the corresponding action. Continuing with the above example, assume that the user selection is directed to the analytical suggestion, but a portion of the GM output associated with the analytical suggestion further indicated that any analysis of the document should be off-loaded to the remote system given the computational requirements of analyzing data in the document to generate charts, graphs, etc. Accordingly, the result of the performance of the corresponding action that is received at the mobile device is the analysis of the data in the document.

In various implementations, the generative content graphical card may further include a free-form natural language input field that enables the processor(s) to receive free-form typed input(s) form the user and/or a microphone element that, when selected, enables the processor(s) to receive free-form spoken input(s) form the user. In these implementations, the processor(s) can cause additional corresponding actions to be performed based on the free-form typed input(s) received from the user and/or the free-form spoken input(s) received from the user. Continuing with the above example, the user can interact with the free-form natural language input field and/or the microphone element to ask a particular question about a particular section of the document or the like. Notably, the processor(s) can process the free-form typed input(s) and/or free-form spoken input(s) to determine whether the corresponding action is a generative action and/or a non-generative action, and the processor(s) can cause the corresponding action to be fulfilled in the same or similar manner described herein.

In various implementations, the processor(s) can cause the plurality of suggestions to be visually rendered as a carousel of suggestions. When initially visually rendered at the client device, the processor(s) may only cause a subset of suggestions, from among the plurality of suggestions, to be visually rendered at the client device. However, the carousel of suggestions enables the user to swipe along the display of the client device to reveal additional suggestions, from among the plurality of suggestions. In some versions of those implementations, a quantity of suggestions, included in the subset of suggestions, is based on a display size of the display of the client device and/or an orientation of the client device. Continuing with the above example, a relatively small quantity of suggestions may be included in the subset of suggestions given the relatively small size of the display of the mobile device compared to, for instance, a laptop or desktop computer. However, more suggestions may be included in the subset of suggestions at the mobile device if it is, for instance, in a landscape orientation as compared to a portrait orientation.

In various implementations, the processor(s) can determine whether the content that is displayed at the client device is first-party (1P) content that is associated with a 1P entity (or the content being displayed is being displayed by a 1P software application that is associated with the 1P entity) or is third-party (3P) content that is associated with a 3P entity (or the content being displayed is being displayed by a 3P software application that is associated with the 3P entity) that is an entity distinct from the 1P entity. As used herein, the term “first-party entity” refers to an entity that develops and/or maintains the GM and/or the additional GM, whereas the term “third-party entity” refers to an entity that is distinct from the entity that develops and/or maintains the GM and/or the additional GM.

In implementations where the content that is displayed at the client device is 1P content or being displayed by a 1P software application, the processor(s) may be able to obtain additional data associated with the displayed content, such as other content associated with, for example, a web page or a software application, but is not within a display of the client device, metadata associated with the web page or the software application, and/or other data.

In these implementations, the additional data can optionally be included in the GM input and/or the additional GM input as described herein. Continuing with the above example, assume that the files software application is a 1P software application. In this example, the processor(s) may obtain the additional data described herein, and also include the additional data in the GM input and/or the additional GM input. Further, in these implementations, the additional data may optionally be stored in association with the displayed content in the on-device memory of the client device.

In implementations where the content that is displayed at the client device is 3P content or being displayed by a 3P software application, the processor(s) may not be able to obtain any additional data associated with the displayed content, may be limited in the additional data associated with the displayed content that can be obtained, or may be limited in the additional data associated with the displayed content that can be stored in the on-device storage. In these implementations, the additional data can optionally be included in the GM input and/or the additional GM input as described herein. Continuing with the above example, assume that the files software application is a 3P software application. In this example, the processor(s) may only be able to perform optical character recognition (OCR) on the portion of the document that is within view of the display when the generative content graphical card is invoked.

By using techniques described herein, various technical advantages can be achieved. As one non-limiting example, by causing the generative content graphical card to overlay content that is displayed at the client device, the user need not switch between tabs, software applications, or the like, thereby reducing a quantity of user inputs received at the client device and, as a result, conserving computational resources by obviating the need to process additional user inputs. As another non-limiting example, by storing the displayed content in the on-device memory of the content, latency in fulfillment of the given suggestion can be reduced since the processor(s) need not re-process the content displayed at the client device. As yet another non-limiting example, by tailoring a quantity of the plurality of suggestions (or a subset thereof) that are visually rendered at the client device based on a size of the display of the client device and/or an orientation of the client device, techniques described herein are dynamically adapted to hardware constraints of the client device, which can vary greatly from client device to client device. As yet another non-limiting example, by determining whether to utilize the on-device GM or the cloud-based additional GM based on hardware constraints of the client device, software constraints of the client device, and/or other client device constraints, the processor(s) can prioritize utilization of the on-device GM to reduce latency and conservation of network resources, but can off-load processing to the cloud-based additional GM as to not waste computational resources consumed in the interaction.

The above description is provided as an overview of some implementations of the present disclosure. Further description of those implementations, and other implementations, are described in more detail below.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts a process flow for utilizing various components from the example environment of FIG. 1, in accordance with various implementations.

FIG. 3 depicts a flowchart illustrating an example method of providing a generative content graphical card, in accordance with various implementations.

FIG. 4 depicts a flowchart illustrating an example method of implementing actions based on interactions with the provided generative content graphical card from FIG. 3, in accordance with various implementations.

FIGS. 5A, 5B, 5C, 5D, 5E, and 5F depict various non-limiting examples of providing a generative content graphical card and implementing actions based on interactions with the provided generative content graphical card, in accordance with various implementations.

FIG. 6 depicts an example architecture of a computing device, in accordance with various implementations.

### DETAILED DESCRIPTION OF THE DRAWINGS

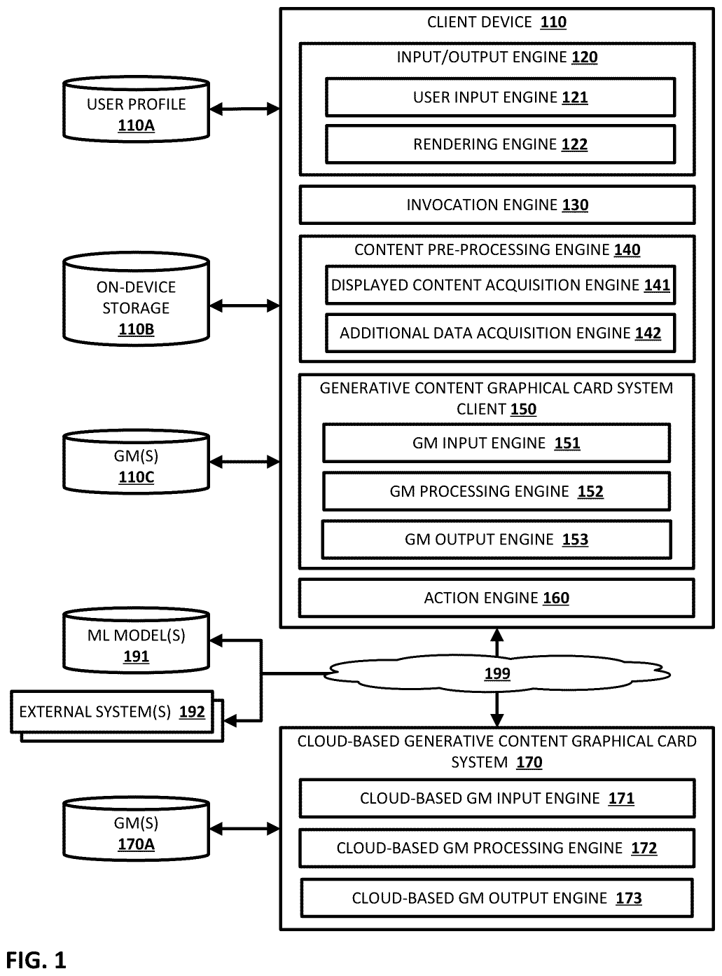

Turning now to FIG. 1, a block diagram of an example environment that demonstrates various aspects of the present disclosure, and in which implementations disclosed herein can be implemented is depicted. The example environment includes a client device 110 and a cloud-based generative content graphical card system 170. In some implementations, all or aspects of the cloud-based generative content graphical card system 170 can be implemented locally at the client device 110 (e.g., via a generative content graphical card system client 150). In additional or alternative implementations, all or aspects of the cloud-based generative content graphical card system 170 can be implemented remotely from the client device 110 as depicted in FIG. 1 (e.g., at remote server(s)). In those implementations, the client device 110 and the cloud-based generative content graphical card system 170 can be communicatively coupled with each other via one or more networks 199, such as one or more wired or wireless local area networks (“LANs,” including Wi-Fi®, mesh networks, Bluetooth®, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more software applications through which touch inputs and/or other user inputs can be submitted and/or content that is responsive to the touch inputs and/or the other user inputs can be rendered (e.g., audibly and/or visually). Notably, the client device 110 can execute one or more of the software applications separately from an operating system of the client device 110 (e.g., one installed “on top” of the operating system), or the client device 110 can execute one or more of the software applications directly by the operating system of the client device 110. For example, the client device 110 can execute a web browser software application, a generative content software application, electronic communications software applications (e.g., email software application(s), messaging software application(s), social media software application(s), etc.), an automated assistant software application, etc. that is installed on top of the operating system of the client device 110. As another example, the client device 110 can execute a web browser software application, a generative content software application, electronic communications software applications (e.g., email software application(s), messaging software application(s), social media software application(s), etc.), an automated assistant software application, etc. that is integrated as part of the operating system of the client device 110.

In various implementations, the client device 110 can include an input/output engine 120 that includes, for example, a user input engine 121 and a rendering engine 121. The user input engine 121 is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to typed and/or touch inputs directed to the client device 110. Additionally, or alternatively, the client device 110 can be equipped with one or more interfaces that are configured to receive content (e.g., document(s), image(s), video(s), audio, etc.) provided by the user of the client device 110.

In some versions of those implementations, the client device 110 can utilize one or more machine learning (ML) model(s) stored in ML model(s) database 191 to process the user input. For example, the user input received at the client device 110 may be a spoken utterance. In these examples, the user input engine 121 can process, using hotword detection model(s) stored in the ML models database 191, audio data that captures the spoken utterance and that is generated by microphone(s) of the client device 110 to determine whether the spoken utterance includes one or more particular words or phrases that, when detected, invoke a generative content graphical card as described herein.

Additionally, or alternatively, the user input engine 121 can process, using automatic speech recognition (ASR) model(s) stored in the ML model(s) database 191 (e.g., a recurrent neural network (RNN) model, a transformer model, and/or any other type of ML model capable of performing ASR), audio data that captures the spoken utterance and that is generated by microphone(s) of the client device 110 to generate ASR output. The ASR output can include, for example, speech hypotheses (e.g., term hypotheses and/or transcription hypotheses) that are predicted to correspond to the spoken utterance captured in the audio data, one or more corresponding predicted values (e.g., probabilities, log likelihoods, and/or other values) for each of the speech hypotheses, a plurality of phonemes that are predicted to correspond to the spoken utterance captured in the audio data, one or more corresponding predicted values (e.g., probabilities, log likelihoods, and/or other values) for each of the plurality of phonemes, and/or other ASR output. In these implementations, the user input engine 121 can select one or more of the speech hypotheses as recognized text that corresponds to the spoken utterance (e.g., based on the corresponding predicted values for each of the speech hypotheses), such as when the user input engine 121 utilizes an end-to-end ASR model. In other implementations, the user input engine 121 can select one or more of the predicted phonemes (e.g., based on the corresponding predicted values for each of the predicted phonemes), and determine recognized text that corresponds to the spoken utterance based on the one or more predicted phonemes that are selected, such as when the user input engine 121 utilizes an ASR model that is not end-to-end. In these implementations, the user input engine 121 can optionally employ additional mechanisms (e.g., a directed acyclic graph) to determine the recognized text that corresponds to the spoken utterance based on the one or more predicted phonemes that are selected.

Further, the rendering engine 112 is configured to render content for audible and/or visual presentation to a user of the client device 110 using one or more user interface output devices. For example, the client device 110 can be equipped with speaker(s) that enable the content to be rendered as audible content via the client device 110. Additionally, or alternatively, the client device 110 can be equipped with a display or projector that enables the content to be rendered as textual content, and optionally along with other visual content (e.g., image(s), video(s), etc.), via the client device 110.

In some implementations, the client device 110 can utilize one or more of the ML model(s) stored in the ML model(s) database 191 to process content described herein. For example, and as noted above, the content can be audibly rendered as audible content via the speaker(s) of the client device 110. In these examples, the rendering engine 121 can process, using text-to-speech (TTS) model(s) stored in the ML model(s) database 191, content (e.g., generated using the generative content graphical card system client 150 and/or the cloud-based generative content graphical card system 170) to generate synthesized speech audio data that includes computer-generated synthesized speech capturing the content.

In various implementations, the client device 110 can include an invocation engine 130. The invocation engine 130 is configured to detect an invocation of a generative content graphical card via a spoken utterance that is received at the client device 110, a gesture that is directed to the client device 110, an actuation of a hardware or software button of the client device 110, etc. For example, user input received at the client device 110 (e.g., and detected via the user input engine 121) may be a spoken utterance. In these examples, the invocation engine 130 can process, using hotword detection model(s) stored in the ML models database 191, audio data that captures the spoken utterance and that is generated by microphone(s) of the client device 110 to determine whether the spoken utterance includes one or more particular words or phrases that, when detected, invoke a generative content graphical card as described herein. As another example, user input received at the client device 110 (e.g., and detected via the user input engine 121) may be a gesture. In these examples, the invocation engine 130 can process, using hotword free invocation model(s) stored in the ML models database 191, vision data that captures the gesture and that is generated by vision component(s) of the client device 110 to determine whether the vision data includes one or more particular gestures that, when detected, invoke a generative content graphical card as described herein. As yet another example, user input received at the client device 110 (e.g., and detected via the user input engine 121) may be an actuation of a hardware button and/or software button of the client device 110 that invokes a generative content graphical card as described herein.

In various implementations, the client device 110 can include a context engine (not depicted for the sake of brevity) that is configured to determine a client device context (e.g., current or recent context) of the client device 110 and/or a user context of a user of the client device 110 (or an active user of the client device 110 when the client device 110 is associated with multiple users). In some of those implementations, the context engine can determine a context based on data stored in user profile database 110A. The data stored in the user profile database 110A can include, for example, user interaction data that characterizes current or recent interaction(s) of the client device 110 and/or a user of the client device 110, location data that characterizes a current or recent location(s) of the client device 110 and/or a geographical region associated with a user of the client device 110, user attribute data that characterizes one or more attributes of a user of the client device 110, user preference data that characterizes one or more preferences of a user of the client device 110, and/or any other data accessible to the context engine via the user profile database 110A or otherwise.

For example, the context engine can determine a current context based on a current state of a dialog session (e.g., considering one or more recent user inputs provided by a user during the dialog session) and/or a current location of the client device 110. For instance, the context engine can determine a current context of “visitor looking for upcoming events in Louisville, Kentucky” based on a recently issued query and an anticipated future location of the client device 110 (e.g., based on recently booked hotel accommodations). As another example, the context engine can determine a current context based on which software application is active in the foreground of the client device 110, a current or recent state of the active software application, and/or content currently or recently rendered by the active software application. A context determined by the context engine can be utilized, for example, in supplementing or rewriting user inputs that are received at the client device 110, in generating an implied user input (e.g., an implied query or prompt formulated independent of any explicit user input provided by a user of the client device 110), and/or in determining to submit an implied user input and/or to render result(s) (e.g., the content) for an implied user input.

Further, the client device 110 and/or the cloud-based generative content graphical card system 170 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household, a workplace, a hotel, etc.).

The client device 110 is illustrated in FIG. 1 as further including a content pre-processing engine 140, the generative content graphical card system client 150, and an action engine 160. Some of these engines can be combined and/or omitted in various implementations. Further, these engines can include various sub-engines. For instance, the content pre-processing engine 140 is illustrated in FIG. 1 as including a displayed content acquisition engine 141 and an additional data acquisition engine 142. Further, the generative content graphical card system client 150 is illustrated in FIG. 1 as including generative model (GM) input engine 151, GM processing engine 152, and GM output engine 153. Similarly, some of these sub-engines can be combined and/or omitted in various implementations. Accordingly, it should be understood that the various engines and sub-engines of the client device 110 illustrated in FIG. 1 are not meant to be limiting.

Further, the cloud-based generative content graphical card system 170 is illustrated in FIG. 1 as including a cloud-based GM input engine 171 that is a cloud-based counterpart of the GM input engine 151, a cloud-based GM processing engine 172 that is a cloud-based counterpart of the GM processing engine 152, and a cloud-based GM output engine 173 that is a cloud-based counterpart of the GM output engine 153. Some of these engines can be combined and/or omitted in various implementations. Accordingly, it should be understood that the various engines and sub-engines of the cloud-based generative content graphical card system 170 illustrated in FIG. 1 are not meant to be limiting.

Further, the client device 110 and the cloud-based generative content graphical card system 170 are illustrated in FIG. 1 as interfacing with various databases, such as the client device 110 interfacing with GM(s) database 110C and the cloud-based generative content graphical card system 170 interfacing with GM(s) database 170, the client device 110 interfacing with the user profile database 110A and on-device storage 110B. In some implementations, each of the various engines and/or sub-engines of the client device 110 and/or the cloud-based generative content graphical card system 170 may have access to each of the various databases, whereas in other implementations, one or more of the databases may be access-restricted. Further, some of these databases can be combined and/or omitted in various implementations. Accordingly, it should be understood that the various databases interfacing with the client device 110 and the cloud-based generative content graphical card system 170 illustrated in FIG. 1 are not meant to be limiting.

Moreover, the client device 110 and the cloud-based generative content graphical card system 170 are illustrated in FIG. 1 as interfacing with other system(s), such as external system(s) 192. The external system(s) can include, for example, search system(s) (e.g., text-based search system(s), image-based search system(s), video-based search system(s), etc.) and/or other generative system(s) (other text-based generative system(s), other image-based generative system(s), other video-based generative system(s), other audio-based generative system(s), etc.). In some implementations, the external system(s) 192 are first-party system(s), whereas in other implementations, the external system(s) 192 are third-party system(s). The client device 110 and/or the cloud-based generative content graphical card system 170 can interact with the external system(s) 192 via application programming interface(s) (API(s)).

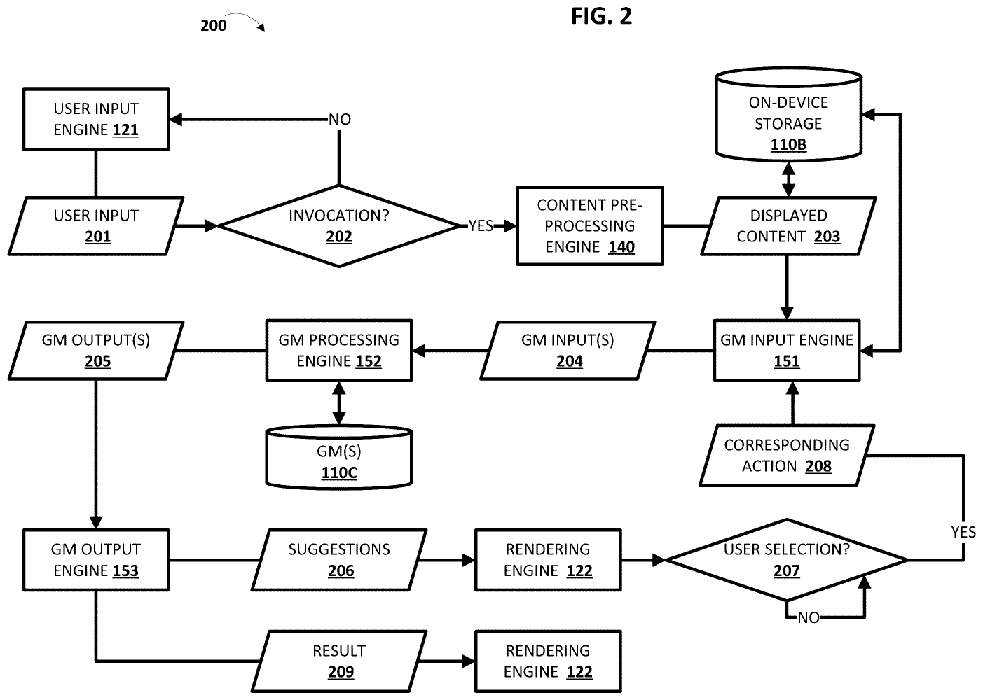

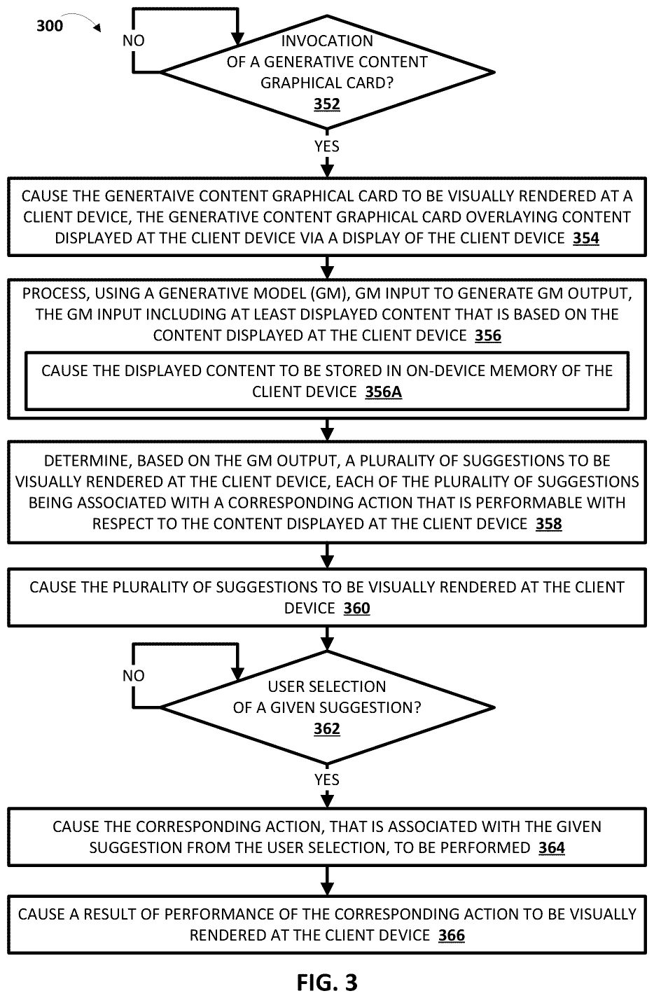

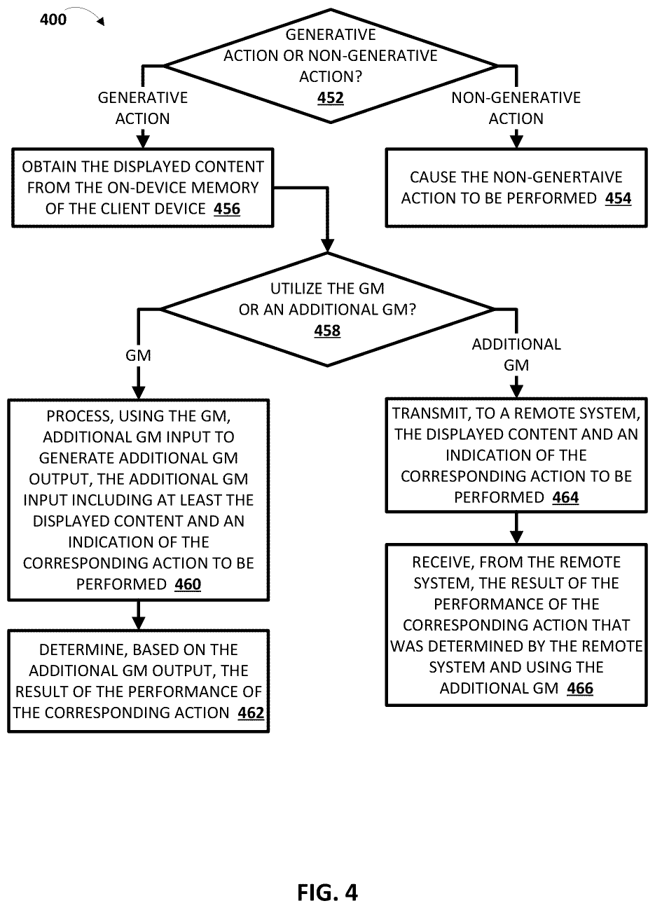

As described in more detail herein (e.g., with respect to FIGS. 2, 3, 4 and 5A-5F), the client device 110 (e.g., via the generative content graphical card system client 150) and/or the cloud-based generative content graphical card system 170 can be utilized to provide a generative content graphical card at the client device 110 and in response to an invocation of the generative content graphical card (e.g., as described with respect to FIG. 3). The generative content graphical card can be provided, for example, along with a plurality of suggestions that are each associated with a corresponding action is performable with respect to displayed content that is associated with content displayed at the client device 110 when the generative content graphical card is invoked. Each of the plurality of suggestions can be selectable and, when a given suggestion is selected from among the plurality of corresponding actions, the client device 110 (e.g., via the generative content graphical card system client 150) and/or the cloud-based generative content graphical card system 170 can be utilized to cause the corresponding action to be performed (e.g., as described with respect to FIG. 4). Further, the generative content graphical card can be provided in such a manner that it overlays the content that is displayed at the client device 110 when the generative content graphical card is invoked. Moreover, not only can the generative content graphical card be presented along with the plurality of suggestions, but the generative content graphical card can also include a free-form natural language input field receive typed and/or spoken inputs to cause other actions (e.g., that are in addition to the corresponding actions associated with respect to the plurality of suggestions) to performed via the client device 110 (e.g., via the generative content graphical card system client 150) and/or the cloud-based generative content graphical card system 170. Accordingly, techniques described herein provide quick and efficient access to various GM(s) that can leverage context of the displayed content that is associated with content displayed at the client device 110 and in lieu of requiring the user to navigate to a dedicated landing page of a web browser associated with the GM(s), access separate software application(s) associated with the GM(s), and/or explicitly upload the content that is displayed at the client device 110 or explicitly build a conversational context throughout turn-based dialogs with system(s) that leverage the GM(s). Additional or alternative technical advantages can be achieved based on techniques described herein.

Notably, in determining the plurality of suggestions that are presented along with the generative content graphical card, the client device 110 (e.g., via the generative content graphical card system client 150) and/or the cloud-based generative content graphical card system 170 can leverage various GM(s). For instance, one or more on-device GM(s) that are stored and executed locally at the client device 110 (e.g., in the GM(s) database 110C) can be utilized by the generative content graphical card system client 150 in determining the plurality of suggestions. The on-device GM(s) that are stored and executed locally at the client device 110 can include, for example, Gemini Nano and/or any other GM that is capable of being stored and executed locally at the client device 110, such as any other GM that is encoder-only based, decoder-only based, sequence-to-sequence based and that optionally includes an attention mechanism or other memory. Also, for instance, one or more cloud-based GM(s) that are stored and executed remotely from the client device 110 (e.g., in the GM(s) database 170A) can be utilized by the cloud-based generative content graphical card system 170 in determining the plurality of suggestions. The cloud-based GM(s) that are stored and executed remotely from the client device 110 can include, for example, Gemini Pro, Gemini Ultra, Bard, GPT, and/or any other GM that is capable of being stored and executed remotely from the client device 110, such as any other GM that is encoder-only based, decoder-only based, sequence-to-sequence based and that optionally includes an attention mechanism or other memory.

In some implementations, the on-device GM(s) can have the same capabilities as the cloud-based GM(s) (e.g., text understanding and generation capabilities, image/video understanding and generation capabilities, audio understanding and generation capabilities, etc.), but have fewer parameters relative to the cloud-based GM(s) such that the cloud-based GM(s) are more robust than the on-device GM(s). In additional or alternative implementations, the on-device GM(s) can have fewer capabilities relative to the cloud-based GM(s) (e.g., text understanding and generation capabilities, but lack one or more of image/video understanding and generation capabilities or audio understanding and generation capabilities, etc.). Whether the on-device GM(s) and/or the cloud-based GM(s) are utilized in determining the plurality of suggestions to be provided along with the generative content graphical card, these GM(s) can be instruction-tuned during inference and/or fine-tuned prior to inference for utilization in determining the plurality of suggestions (e.g., as described in more detail with respect to FIG. 2). Moreover, and depending on how the user of the client device 110 interacts with the generative content graphical card, the on-device GM(s) and/or the cloud-based GM(s) may be utilized in causing action(s) to be performed. Additional details of the various engine and sub-engines depicted in FIG. 1 are provided herein.

Turning now to FIG. 2, a process flow for utilizing various components from the example environment of FIG. 1 is depicted. For the sake of example, assume that the user input engine 121 detects user input 201. As indicated at block 202, the invocation engine 130 can process the user input 201 detected via the user input engine 121 to determine whether the user input invokes a generative content graphical card (e.g., based on the user of the client device 110 speaking a particular word or phrase at the client device 110, based on the user of the client device 110 actuating a hardware button and/or software button of the client device 110). Assuming the invocation engine 130 determines that the user input 201 does not invoke the generative content graphical card, the invocation engine 130 can continue monitoring further user inputs for an invocation of the generative content graphical card (and while fulfilling the user input 201). However, assuming the invocation engine 130 determines that the user input 201 does invoke the generative content graphical card, the invocation engine 130 can cause the content pre-processing engine 140 to process content that is displayed at the client device 110 to determine displayed content.

For example, and in response to receiving an invocation of the generative content graphical card, the displayed content pre-processing engine 141 can process the content that is displayed at the client device 110 to determine the displayed content 203. For instance, the displayed content pre-processing engine 141 can perform optical character recognition (OCR) on the content that is displayed at the client device 110 to determine the displayed content 203, image recognition on the content that is displayed at the client device 110 to determine the displayed content 203, and/or other operations to extract the displayed content 203. Additionally, or alternative, the displayed content pre-processing engine 141 can cause a screenshot of the content that is displayed at the client device 110 to be taken and the screenshot can be utilized as the displayed content 203 and without performing additional processing on the screenshot (e.g., not performing any OCR, image recognition, etc.). Further, the displayed content pre-processing engine 141 can cause the displayed content 203 to be stored in the on-device storage 110B of the client device 110 to enable quick and efficient access to the displayed content 203 for subsequent processing thereof.

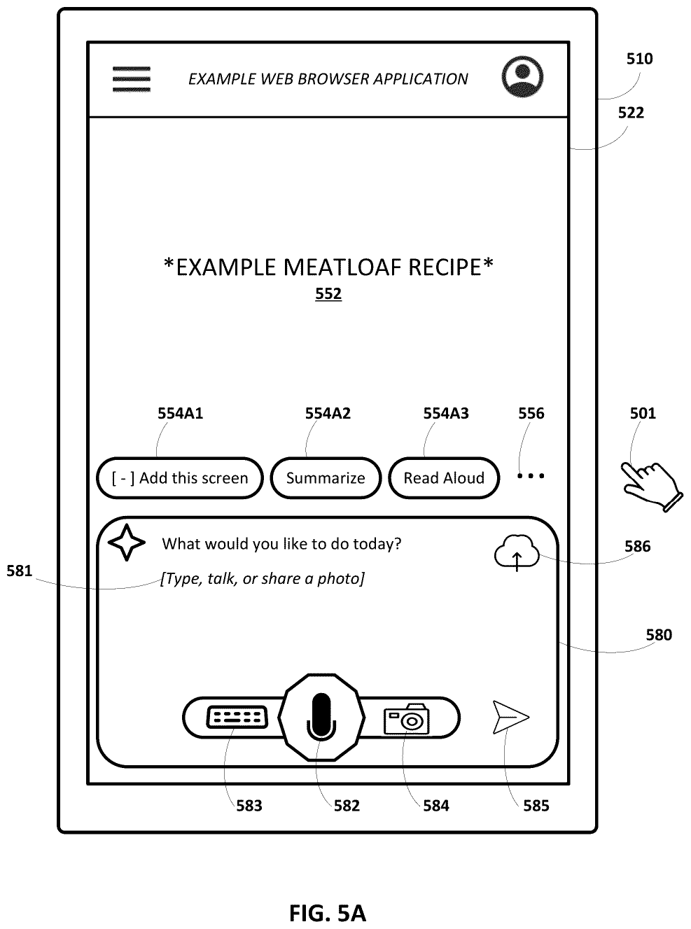

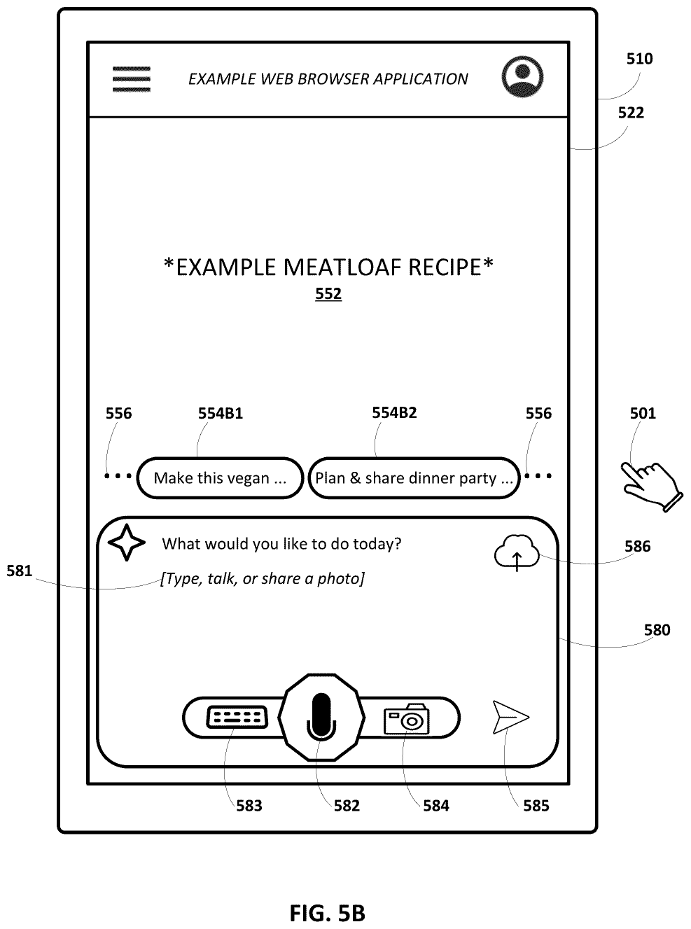

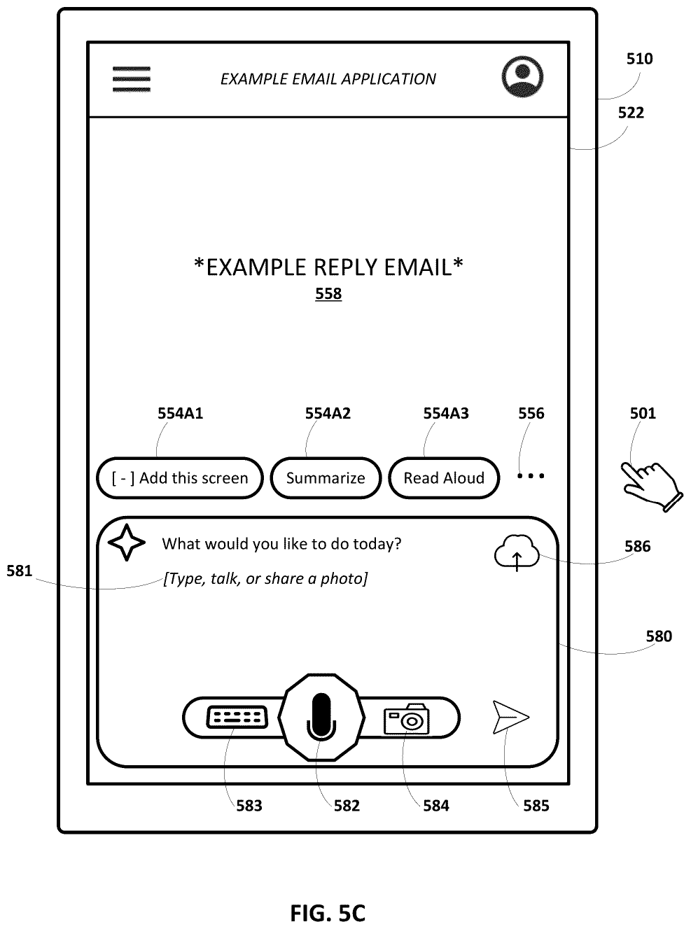

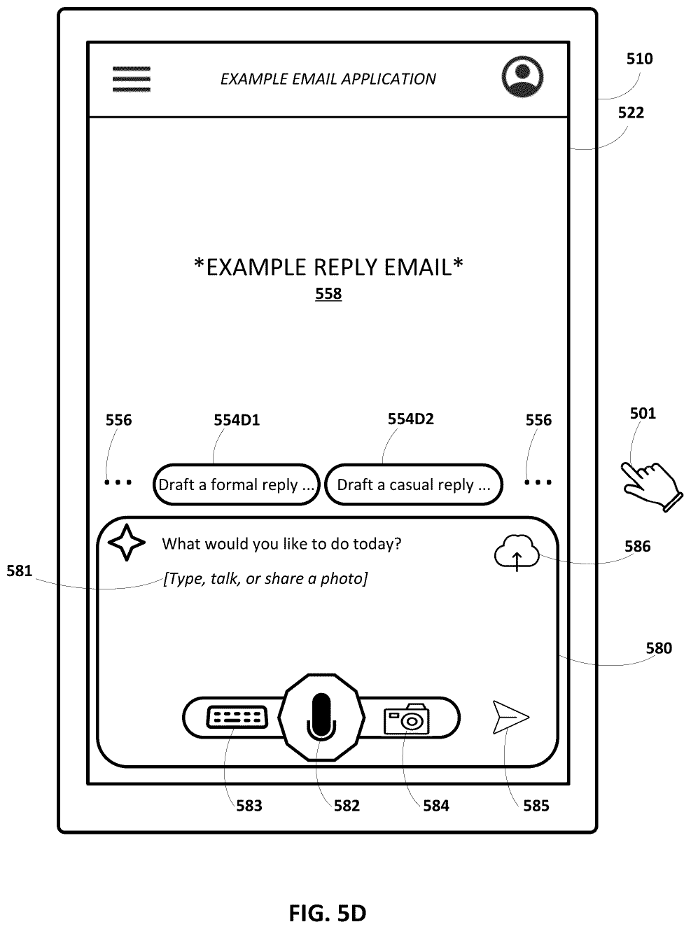

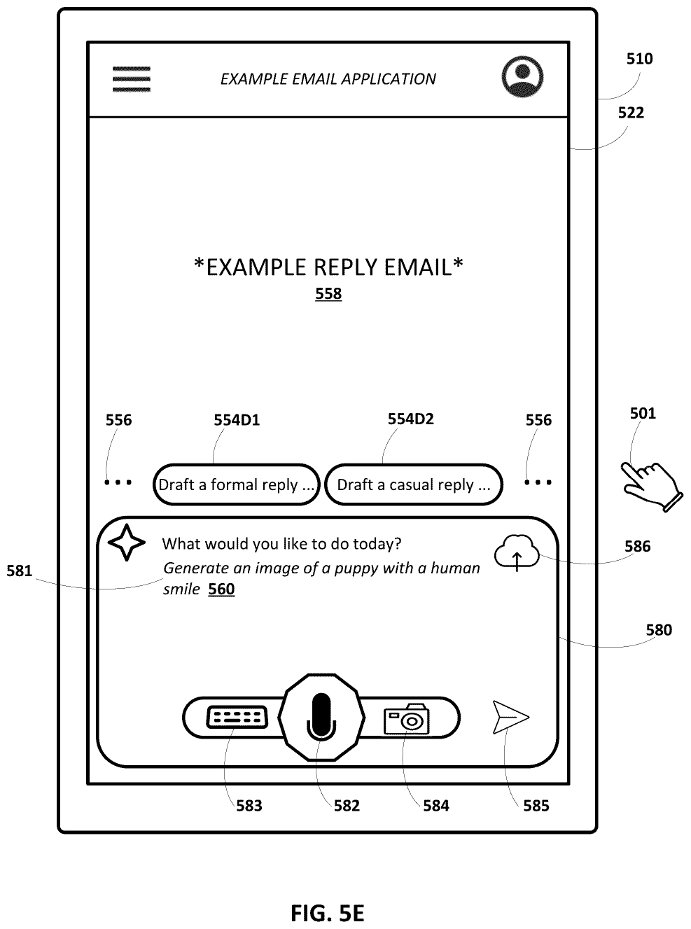

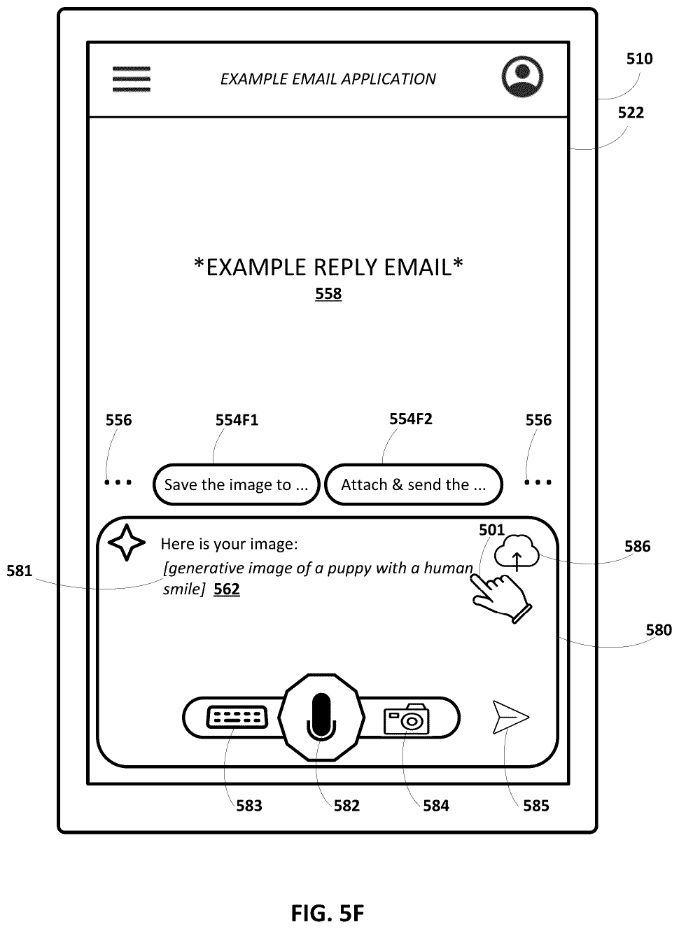

In some implementations, the displayed content pre-processing engine 141 may only process the content that is displayed at the client device 110 to determine the displayed content 203 in response to receiving a user confirmation via a selectable element that is visually rendered along with presentation of the generative content graphical card (e.g., based on a user confirmation directed to selectable element 554A1 of FIG. 5A). In these implementations, the plurality of suggestions that are determined based on the displayed content 203 may only be visually rendered for presentation to the user of the client device 110 subsequent to receiving the user confirmation. However, in other implementations, the displayed content pre-processing engine 141 may automatically process the content that is displayed at the client device 110 to determine the displayed content 203 in response to receiving the invocation of the generative content graphical card. In these implementations, the plurality of suggestions that are determined based on the displayed content 203 may automatically be visually rendered for presentation to the user of the client device 110 subsequent to receiving the user confirmation.

In some implementations, the additional data acquisition engine 142 can process additional content that is in addition to the content that is displayed at the client device 110 to determine the additional data. For instance, the additional data can include metadata that is associated with the content that is displayed at the client device 110, content associated with a web page or software application that is being accessed but not in view of the display of the client device 110, historical user interaction data associated with a web page or software application that is being accessed, and/or other additional data. Further, the additional data acquisition engine 142 can cause the additional data to be stored in the on-device storage 110B of the client device 110, and in association with the displayed content 203, to enable quick and efficient access to the displayed content for subsequent processing thereof. In some versions of those implementations, the additional data acquisition engine 142 may only determine the additional data in response to determining that the content that is displayed at the client device 110 is first-party (1P) content. Put another way, the additional data acquisition engine 142 may not determine any additional data in response to determining that the content that is displayed at the client device 110 is third-party (3P) content (e.g., due to data privacy and/or data security considerations).

The GM input engine 151 can determine GM input(s) 204. The GM processing engine 152 can process, using GM(s) stored in the GM(s) database 110C, the GM input(s) 204 to generate GM output(s) 205. Moreover, the GM output engine 153 can determine, based on the GM output(s) 205, a plurality of suggestions 206 to be visually rendered for presentation to the user of the client device 110 and along with the generative content graphical card via the rendering engine 122.

The GM input(s) 204 can include, for example, the displayed content 203. In implementations where the GM(s) are instruction-tuned at inference as noted above with respect to FIG. 1, the GM input(s) 204 can further include, for example, a system prompt to generate the GM output(s) 205 based on which the plurality of suggestions 206 can be determined. In this example, the system prompt can include, for example, a quantity of the plurality of suggestions 206 that are to be determined (which can optionally be based on a size of a display of the client device 110), a maximum length of text representing the corresponding actions associated with each of the plurality of suggestions 206, an indication of action parameter(s) associated with each of the plurality of suggestions 206, one or more zero-shot examples in structured format for generating the plurality of suggestions 206, and/or other content. By instruction-tuning the GM(s) at inference via inclusion of the system prompt in the GM input(s) 204, the GM(s) need not be previously fine-tuned to generate the GM output(s) 205 based on which the plurality of suggestions 206 can be determined.

In implementations where the GM(s) are fine-tuned prior to inference as noted above with respect to FIG. 1, the GM input(s) 204 need not include the above-noted system prompt. In some versions of those implementations, the GM(s) can be fine-tuned based on a plurality of fine-tuning instances. Each of the plurality of fine-tuning instances can include corresponding fine-tuning displayed content, and corresponding fine-tuning suggestions for the corresponding fine-tuning displayed content. Accordingly, in fine-tuning the GM(s) based on a given fine-tuning instance, of the plurality of fine-tuning instances, the corresponding fine-tuning displayed content can be processed, using the GM(s), to determine predicted suggestions for the corresponding fine-tuning displayed content. Further, the predicted suggestions for the corresponding fine-tuning displayed content can be compared to the corresponding fine-tuning suggestions for the corresponding fine-tuning displayed content to generate one or more losses. Moreover, the GM(s) can be updated based on one or more of the losses. Although particular learning techniques for fine-tuning the GM(s) are described above (e.g., supervised fine-tuning (SFT) techniques) it should be understood that is for the sake of example and is not meant to be limiting.

For instance, the GM(s) can be fine-tuned based on reinforcement learning from human feedback (RLHF) where the predicted suggestions for the corresponding fine-tuning displayed content are provided for presentation to a developer associated with the GM(s) (or another human user) and the developer (or the other human user) can provide feedback with respect to the predicted suggestions for the corresponding fine-tuning displayed content that was processed using the GM(s). For instance, the feedback can relate to how helpful the predicted suggestions are for the corresponding fine-tuning displayed content, how accurate the predicted suggestions are for the corresponding fine-tuning displayed content, etc. Notably, the feedback can be provided for the predicted suggestions as a whole or based on a suggestion-by-suggestion basis. Based on the feedback, a reward model can be utilized to generate a reward (e.g., positive reward or negative reward) that can be utilized to update the GM(s).

Further, the GM output(s) 205 can include, for example, a probability distribution over a sequence of tokens. The sequence of tokens can correspond to, for instance, candidate suggestions for actions that are performable with respect to the displayed content 203 and/or corresponding action parameter(s) for the candidate suggestion(s). Put another way, and based on the instruction-tuning and/or fine-tuning of the GM(s), the GM(s) are capable of generating the GM output(s) 205 that are indicative of the actions and/or action parameter(s) that are performable with respect to the displayed content 203 and that are predicted to be useful to the user of the client device and given the context of the displayed content 203. Thus, the GM output engine 153 can utilize various decoding techniques to select the plurality of suggestions 206 and based on the probability distribution over the sequence of tokens, and the plurality of suggestions 206 can be visually rendered for presentation to the user of the client device 110 and along with the generative content graphical card via the rendering engine 122.

Subsequent to causing the plurality of suggestions 206 to be visually rendered for presentation displayed content 203, the user input engine 121 can monitor for a user selection of a given suggestion, from among the plurality of suggestions 206, at the client device 110 as indicated at 207. Assuming that no user selection is received, the user input engine 121 can continue monitoring for a user selection of a given suggestion, from among the plurality of suggestions 206, at the client device 110 as indicated at 207 and while the generative content graphical card is visually rendered. However, assuming that a user selection of a given suggestion is received, the action engine 160 can cause a corresponding action 208 that is associated with the given suggestion that was selected to be performed. In some implementations, the corresponding action 208 may be a non-generative action that does not require further utilization of any GM(s). However, in other implementations, the corresponding action 208 may be a generative action that does require further utilization of the GM(s).

For the sake of example in FIG. 2, further assume that the corresponding action 208 is a generative action that does require further utilization of the GM(s). In this example, the action engine 160 can cause an indication of the corresponding action to be provided to the GM input engine 208. The GM input engine 151 can determine additional GM input(s) that include at least the displayed content 208 (e.g., obtained from the on-device storage 110B of the client device) and an indication of the corresponding action 208 to be performed in response to receiving the user selection of the given suggestion. Further, the GM processing engine 152 can process, using the GM(s) stored in the GM(s) database 110C, the additional GM input(s) to generate additional GM output(s). Moreover, the GM output engine 153 can determine, based on the additional GM output(s), a result 209 of performance of the corresponding action 208 and cause the result of the corresponding action be visually rendered for presentation to the user of the client device 110 via the rendering engine 122. Notably, the corresponding action 208 to be performed will vary based on the given suggestion that is selected by the user. Various non-limiting examples of actions that are performable with respect to the displayed content are described herein (e.g., with respect to FIGS. 5A-5F).

Although the process flow 200 of FIG. 2 is described with respect to the plurality of suggestions 206 and the result 209 of the performance of the corresponding action 208 being determined using the GM(s) that are stored and executed locally at the client device 110, it should be understood that is for the sake of example and is not meant to be limiting. For instance, in other implementations, GM(s) that are stored and executed remotely from the client device 110 can be utilized (e.g., stored in the GM model(s) database 170A). In these implementations, the GM input engine 171, the GM processing engine 172, and the GM output engine 173 can be utilized in lieu of the GM input engine 151, the GM processing engine 152, and the GM output engine 153, respectively. Notably, functionality of these cloud-based GM engines can be the same or similar to the functionality described above with respect to the on-device GM engines, but they are executed remotely from the client device 110.

Also, for instance, the GM(s) that are stored and executed locally at the client device 110 can be utilized in determining the plurality of suggestions 206, but GM(s) that are stored and executed remotely from the client device 110 and/or the GM(s) that are stored and executed remotely from the client device 110 can be selectively utilized in causing the corresponding action 208 to be implemented (e.g., as described with respect to FIG. 4). In these implementations, the GM(s) that are stored and executed locally at the client device 110 can be utilized in determining the plurality of suggestions 206 to reduce latency in causing the plurality of suggestions 206 to be visually rendered, but the action engine 160 can utilize one or more criteria to determine whether to cause the corresponding action 208 to be implemented using the on-device GM(s) and/or the cloud-based GM(s).

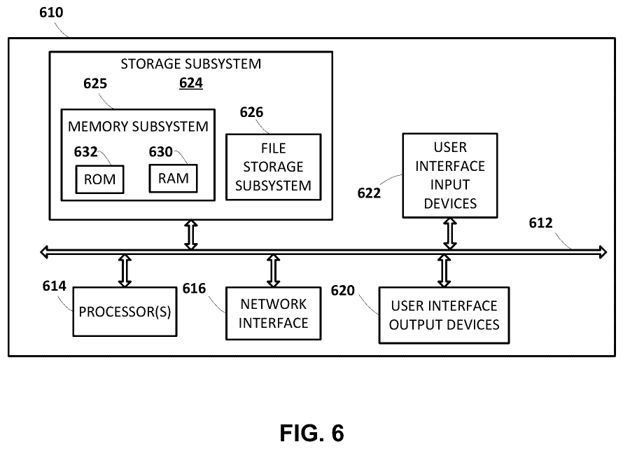

Turning now to FIG. 3, a flowchart illustrating an example method 300 of providing a generative content graphical card is depicted. For convenience, the operations of the method 300 are described with reference to a system that performs the operations. This system of the method 300 includes one or more processors, memory, and/or other component(s) of computing device(s) (e.g., client device 110 of FIG. 1, cloud-based generative content graphical content system 170 of FIG. 1, computing device 610 of FIG. 6, one or more servers, and/or other computing devices). Moreover, while operations of the method 300 are shown in a particular order, this is not meant to be limiting. One or more operations may be reordered, omitted, and/or added.

At block 352, the system determines whether an invocation of a generative content graphical card has been received at a client device of a user. For example, the invocation of the generative content graphical card can be based on a spoken utterance that is provided by the user of the client device and that is captured in audio data generated by microphone(s) of the client device, a gesture that is provided by the user of the client device and that is captured in vision data generated by vision component(s) of the client device, an actuation of a hardware button and/or software button of the client device, a touch gesture directed to a display of the client device, and/or by other means (e.g., as described with respect to the invocation engine 130 of the client device 110).

If, at an iteration of block 352, the system receives no invocation of a generative content graphical card, then the system continues to monitor for invocation of a generative content graphical card. Notably, while the system is monitoring for the invocation of the generative content graphical card, the system can receive and process other user inputs that are directed to the client device.

If, at an iteration of block 352, the system receives an invocation of a generative content graphical card, then the system proceeds to block 354. At block 354, the system causes the generative content graphical card to be visually rendered at a client device, the generative content graphical card overlaying content displayed at the client device via a display of the client device. Some non-limiting examples of the generative content graphical card are described herein (e.g., with respect to FIGS. 5A-5F).

At block 356, the system processes, using a generative model (GM), GM input to generate GM output, the GM output including at least displayed content that is based on content displayed at the client device. For example, the GM input can include the displayed content that is determined based on the content that is displayed at the client device (e.g., as described with respect to the displayed content acquisition engine 141 and the GM input engine 151 of FIGS. 1 and 2), additional data that is associated with the content that is displayed at the client device (e.g., as described with respect to the additional data acquisition engine 142 and the GM input engine 151 of FIGS. 1 and 2), a system prompt for instruction-tuning of the GM (e.g., as described with respect to the process flow 200 of FIG. 2), and/or other content or data described herein. In some implementations, block 356 may include sub-block 356A. At sub-block 356A, the system can cause the displayed content (and optionally any other additional data that is obtained) to be stored in on-device memory of the client device. By storing the displayed content (and any of the other additional data that is obtained) in the on-device memory of the client device, latency in subsequent processing by the GM(s) can be reduced since the displayed content (and any of the other additional data that is obtained) is readily available via the on-device memory of the client device.

At block 358, the system determines, based on the GM output, a plurality of suggestions to be visually rendered at the client device, each of the plurality of suggestions being associated with a corresponding action that is performable with respect to the content displayed at the client device. For example, the GM output can correspond to a probability distribution over a sequence of tokens where the tokens correspond to candidate actions that can be performed based on the content that is displayed at the client device, and the plurality of suggestions can be determined based on the probability distribution over the candidate actions (e.g., as described with respect to the GM processing engine 152 and the GM output engine 153 of FIGS. 1 and 2).

At block 360, the system causes the plurality of suggestions to be visually rendered at the client device. For example, the system can cause the plurality of suggestions to be visually rendered along with the generative content graphical card (e.g., as described with respect to the rendering engine 122 of FIGS. 1 and 2).

At block 362, the system determines whether a user selection of a given suggestion, from among the plurality of suggestions, has been received. The user selection can be, for example, a voice selection captured in a spoken utterance that references the given suggestion (e.g., by speaking a presentation order of the given suggestion or by speaking text displayed for the given suggestion), a touch selection (e.g., by directing a tap to the given suggestion) for the given suggestion, and/or other forms of selections.

If, at an iteration of block 362, the system receives no user selection of a given suggestion, then the system continues to monitor for a user selection of a given suggestion at block 362. Although the system may receive no user selection of a given suggestion, the system can receive other user inputs at the generative content graphical card, such as free-form natural language inputs that are typed and/or spoken (e.g., as described with respect to FIG. 5E). In these instances, the system can process those free-form natural language inputs to generate or determine responsive content that is responsive to those free-form natural language inputs. In some of these instances, the system can update the plurality of suggestions based on the free-form natural language inputs and/or the responsive content that is generated or determined based on processing those free-form natural language inputs, and cause the updated plurality of suggestions to replace the plurality of suggestions that were initially visually rendered at the client device of the user (e.g., as described with respect to FIG. 5F).

If, at an iteration of block 362, the system receives a user selection of a given suggestion, then the system proceeds to block 364. At block 364, the system causes the corresponding action, that is associated with the given suggestion from the user suggestion, to be performed. At block 366, the system causes a result of performance of the corresponding action to be visually rendered at the client device. Notably, the corresponding action and the result of the performance of the corresponding action can vary based on the given suggestion that is selected by the user. As described in more detail with respect to FIG. 4, the corresponding action may be a generative action that requires utilization of the GM (e.g., that was utilized in to process the GM input to generate the GM output at block 356) or an additional GM (e.g., that is in addition to the GM that was utilized in to process the GM input to generate the GM output at block 356).

Turning now to FIG. 4, a flowchart illustrating an example method 400 of implementing actions based on interactions with the provided generative content graphical card from FIG. 3 is depicted. For convenience, the operations of the method 400 are described with reference to a system that performs the operations. This system of the method 400 includes one or more processors, memory, and/or other component(s) of computing device(s) (e.g., client device 110 of FIG. 1, cloud-based generative content graphical content system 170 of FIG. 1, computing device 610 of FIG. 6, one or more servers, and/or other computing devices). Moreover, while operations of the method 400 are shown in a particular order, this is not meant to be limiting. One or more operations may be reordered, omitted, and/or added.

At block 452, the system determines whether the corresponding action to be performed at block 364 of the method 300 of FIG. 3 is a generative action or a non-generative action. The system can determine whether the corresponding action to be performed at block 364 of the method 300 of FIG. 3 is a generative action or a non-generative action based on whether utilization of the GM (e.g., that was utilized in to process the GM input to generate the GM output at block 356) or an additional GM (e.g., that is in addition to the GM that was utilized in to process the GM input to generate the GM output at block 356) is required to perform the corresponding action.

Some non-limiting examples of non-generative actions include: performing automatic speech recognition (ASR) for a user based on a spoken utterance that is provided by the user, performing text-to-speech (TTS) for a user based on the content that is displayed at the client device, creating a calendar entry on behalf of the user via a calendar application, creating a notes or reminder via a notes or reminders software application, setting a timer via a clock or timer application, and/or other actions that do not require utilization of the GM or the additional GM. Some non-limiting examples of generative actions include: generating a summary of the content that is displayed at the client device, generating an electronic communication based on the summary of the content that is displayed at the client device, generating visual content (e.g., image content or video content) based on the content that is displayed at the client device or based on other user inputs provided by the user, and/or other actions that require utilization of the GM or the additional GM.

In some instances, the corresponding action may include one or more aspects that require utilization of the GM or the additional GM, but also include one or more additional aspects that do not require utilization of the GM or the additional GM. In these instances, the corresponding action may still be considered a generative action, and subsequent processing of additional GM input(s) can include an indication of application programming interface (API) calls to be made to various software application(s) and/or other system(s), such as other tools, extensions, plug-ins, etc. that can utilize generative content that is generated using the GM or the additional GM.

If, at an iteration of block 452, the system determines the corresponding action to be performed is a non-generative action, the system proceeds to block 454. At block 454, the system causes the non-generative action to be performed. For example, the system can cause the client device to perform the non-generative action by sending instructions (e.g., structured requests) to various component(s) and/or software application(s) that are accessible at the client device.

If, at an iteration of block 452, the system determines the corresponding action to be performed is a generative action, the system proceeds to block 456. At block 456, the system obtains the displayed content from the on-device memory of the client device. However, in implementations where the system omits sub-block 356A from the method 300 of FIG. 3, the system may re-obtain the displayed content in the same or similar manner as described with respect to block 356 and sub-block 356A.

At block 458, the system determines whether to utilize the GM (e.g., implemented by the GM from block 356 of the method 300 of FIG. 3) or an additional GM (e.g., implemented by a remote system that is remote from the client device). The system can determine whether to utilize the GM or the additional GM based on one or more criteria. The one or more criteria can include, for example, one or more of: whether the GM is capable of causing the corresponding action to be performed, whether the additional GM is capable of causing the corresponding action to be performed, whether the GM output specifies the GM or the additional GM should be utilized in causing the corresponding action to be performed, whether the client device has at least a threshold state of charge, weather a threshold quantity of computational resources are available at the client device to cause the corresponding action to be performed, a network connection status of the client device, hardware constraints of the client device, or software constraints of the client device. Put another way, the system can balance criteria related to capabilities of the GM relative to capabilities of the additional GM, dynamic hardware constraints of the client device (e.g., current battery level, current availability of computational resources at the client device, current availability of on-device memory of the client device, etc.), static hardware constraints of the client device (e.g., a type of processor(s) of the client device, a size of the on-device storage of the client device), and/or other criteria in determining whether to utilize the GM that is stored locally at the client device or the additional GM that is remote from the client device in causing the corresponding action to be performed.

If, at an iteration of block 458, the system determines to utilize the GM, the system proceeds to block 460. At block 460, the system processes, using the GM, additional GM input to generate additional GM output, the additional GM input including at least the displayed content and an indication of the corresponding action to be performed. At block 464, the system determines, based on the additional GM output, the result of the performance of the corresponding action. The system can process the additional GM input to generate the additional GM output in the same or similar manner described herein (e.g., with respect to the GM input engine 151, the GM processing engine 152, and the GM output engine 153 from FIGS. 1 and 2), and determine the result of the performance of the corresponding action based on the GM output. Various non-limiting examples of the result of the performance of the corresponding action are described herein.

If, at an iteration of block 458, the system determines to utilize the additional GM, the system proceeds to block 464. At block 464, the system transmits, to a remote system, the displayed content and an indication of the corresponding action to be performed. At block 466, the system receives, from the remote system, the result of the performance of the corresponding action that was determined by the remote system and using the additional GM. Notably, transmitting the displayed content and the indication of the corresponding action to be performed to the remote system causes the remote system to: process, using the additional GM, additional GM input to generate additional GM output, the additional GM input including at least the displayed content and an indication of the corresponding action to be performed; and determine, based on the additional GM output, the result of the performance of the corresponding action. Put another way, the system can cause the remote system to process the additional GM input to generate the additional GM output in the same or similar manner described herein to determine the result of the performance of the corresponding action based on the GM output (e.g., with respect to the GM input engine 171, the GM processing engine 172, and the GM output engine 173 from FIGS. 1 and 2), and receive the result of the performance of the corresponding action from the remote system. Various non-limiting examples of the result of the performance of the corresponding action are described herein.

In various implementations, and prior to causing the displayed content and/or the indication of the corresponding action to be performed to be transmitted to the remote system, the system can prompt the user to authorize transmission of the displayed content and/or the indication of the corresponding action to be performed to the remote system. Assuming the user authorizes the transmission of the displayed content and/or the indication of the corresponding action to be performed to the remote system, the system can proceed with the transmitting. However, assuming the user does not authorize the transmission of the displayed content and/or the indication of the corresponding action to be performed to the remote system, the system may attempt to utilize the on-device GM in performance of the corresponding action, but such utilization may cause the client device to drop below a threshold state of charge, exceed desired computational resource consumption, etc.

Turning now to FIGS. 5A, 5B, 5C, 5D, 5E, and 5F, various non-limiting examples of providing a generative content graphical card and implementing actions based on interactions with the provided generative content graphical card are depicted. A client device 510 (e.g., an instance of the client device 110 from FIG. 1) may include various user interface components including, for example, microphone(s) to generate audio data based on spoken utterances and/or other audible input, speaker(s) to audibly render synthesized speech and/or other audible output, and/or a display 522 to visually render visual output.

For the sake of example, assume the display 522 of the client device 510 is visually rendering a generative content graphical card 580 and in response to an invocation of the generative content graphical card 580. The generative content graphical card 580 can include, for example, a free-form natural language input field 581 that enables a user of the client device 510 to provide typed inputs (and optionally in response to selecting a keyboard interface element 583), a microphone interface element 582 that enables the user of the client device 510 to provide spoken inputs in response to selecting the microphone interface element 582—or just by speaking without necessarily selecting the microphone interface element 582 (i.e., the client device 510 may monitor for one or more terms or phrases, gesture(s) gaze(s), mouth movement(s), lip movement(s), and/or other conditions to activate spoken input, a vision capturing interface element 584 that enables the user of the client device 510 to provide visual inputs (e.g., images/videos in a photo/video album of the client device 510 and/or images/videos captures in response to a selection of the vision capturing interface element 584), a submission interface element 585 that enables the user of the client device 510 to submit any content provided in natural language (e.g., typed or spoken) to a system (e.g., the generative content graphical card system client 150 and/or the cloud-based generative content graphical card system 170), and a sharing interface element 586 that enables the user of the client device 510 to share or download any content (or a link thereto) generated by the system (e.g., the generative content graphical card system client 150 and/or the cloud-based generative content graphical card system 170) via one or more other software application(s) (e.g., electronic communications software application(s) (e.g., an email software application, a text or SMS messaging software application, or the like), social media software application(s), cloud storage software application(s), etc.), photo/video album software application(s), etc.

Although the client device 510 depicted in FIGS. 5A, 5B, 5C, 5D, 5E, and 5F is a mobile phone, it should be understood that is for the sake of example and is not meant to be limiting. For example, the client device 510 may be a standalone speaker with a display, a standalone speaker without a display, a home automation device, an in-vehicle system, a laptop, a desktop computer, and/or any other device capable of executing the system described herein (the generative content graphical card system client 150 and/or the cloud-based generative content graphical card system 170) that provides the generative content graphical card 580.

Referring specifically to FIG. 5A, assume that a user of the client device 510 is viewing an example meatloaf recipe as indicated at 552 and via an example web browser application of the client device 510 when the generative content graphical card 580 is invoked. In some implementations, selectable element 554A1 may be the only other content that is visually rendered along with the generative content graphical card 580. Put another way, a plurality of suggestions associated with corresponding actions that are performable with respect to the example meatloaf recipe may not be initially provided until the selectable element 554A1 is selected to cause content that is displayed at the client device 510 to be processed to determine the plurality of suggestions. However, in other implementations, the plurality of suggestions may be determined without waiting for the selection of the selectable element 554A1.

Further assume that the user of the client device 510 makes the user selection of the selectable element 554A1 and the plurality of suggestions are determined (e.g., as described with respect to FIGS. 2 and 3). In this example, the plurality of suggestions can be determined. For example, and as shown in FIG. 5A, a first suggestion 554A2 and a second suggestion 554A3 are illustrated. The first suggestion 554A2 can be associated with summarizing the content that is displayed at the client device 510 and, when selected, will cause the meatloaf recipe to be summarized (e.g., one example of a generative action). For instance, the ingredients and instructions for preparing the ingredients can be summarized and presented in bullet point format. Further, the second suggestion 554A3 can be associated with reading the content that is displayed at the client device 510 aloud (e.g., using TTS operations) and, when selected, will cause the meatloaf recipe to be audibly rendered via speaker(s) of the client device 510 (e.g., one example of a non-generative action). For instance, the text included in the example web browser for the meatloaf recipe can be audibly rendered for presentation to the user.

Notably, the first suggestion 554A2 and the second suggestion 554A3 may only be a subset of the plurality of suggestions that are initially visually rendered at the client device 510, but other suggestions may be available as indicated by the ellipses 556. Accordingly, to reveal the other suggestions, the user can swipe horizontally along the subset of suggestions as indicated by a hand 501 of the user of the client device 510 (e.g., the plurality of suggestions is visually rendered as a carousel of suggestions). In some implementations, the first suggestion 554A2 and the second suggestion 554A3 may be considered static suggestions in that they may be provided by any underlying content that is displayed at the client device 510 of the user since any underlying content (or displayed content determined based on the content that is displayed at the client device) can be summarized and/or read aloud to the user of the client device 510. However, one or more of the other suggestions that are determined may be considered dynamic suggestions in that they are specifically tailored to the content that is displayed at the client device 510.

For example, and referring specifically to FIG. 5B, assume that the user in FIG. 5A horizontally swiped along the carousel of suggestions to reveal some of the other suggestions. For instance, and as shown in FIG. 5B, a third suggestion 554B1 and a fourth suggestion 554B2 are illustrated. The third suggestion 554B1 can be associated with generating a vegan meatloaf recipe that is based on the example meatloaf recipe displayed at the client device 510 of the user and, when selected, will cause the vegan meatloaf recipe that is based on the example meatloaf recipe displayed at the client device 510 to be generated (e.g., a generative action). For instance, the GM model can be utilized to determine a vegan substitute for the meat that is utilized in the meatloaf (such as tofu) and any other ingredients that need to be adapted for the vegan version of the meatloaf can be determined, summarized, and presented in bullet point format or another user-digestible format. Further, the fourth suggestion 554B2 can be associated with generating a dinner party menu based on the example meatloaf recipe and causing the dinner party menu to be shared with other users and, when selected, will cause the dinner party menu to be generated and exported to an electronic communications channel for quick and efficient sharing of the dinner party menu (e.g., a generative action). For instance, the GM model can be utilized to determine appetizers, desserts, and cocktails that pair well with the example meatloaf recipe to generate the dinner party menu (and optionally utilizing various API calls to external systems, such as search systems), and then generate a draft message or email including the dinner party menu, such that the user of the client device 510 only need to specify one or more recipients to cause the draft message to be transmitted to respective client devices of the one or more recipients.

As another example, and referring specifically to FIG. 5C, assume that a user of the client device 510 is viewing an example reply email as indicated at 558 and via an example email application of the client device 510 when the generative content graphical card 580 is invoked. In some implementations, selectable element 554A1 may be the only other content that is visually rendered along with the generative content graphical card 580. Put another way, a plurality of suggestions associated with corresponding actions that are performable with respect to the example meatloaf recipe may not be initially provided until the selectable element 554A1 is selected to cause content that is displayed at the client device 510 to be processed to determine the plurality of suggestions. However, in other implementations, the plurality of suggestions may be determined without waiting for the selection of the selectable element 554A1.

Further assume that the user of the client device 510 makes the user selection of the selectable element 554A1 and the plurality of suggestions are determined (e.g., as described with respect to FIGS. 2 and 3). In this example, the plurality of suggestions can be determined. For example, and as shown in FIG. 5C, the first suggestion 554A2 and the second suggestion 554A3 are illustrated. As noted above with respect to FIG. 5A, the first suggestion 554A2 and the second suggestion 554A3 may be static suggestions. However, the first suggestion 554A2 can be associated with summarizing the content that is displayed at the client device 510 and, when selected, will cause the email thread to be summarized (e.g., one example of a generative action). For instance, various participants in the email thread can be identified, topics covered by the various participants can be provided, etc. Further, the second suggestion 554A3 can be associated with reading the content that is displayed at the client device 510 aloud (e.g., using TTS operations) and, when selected, will cause the email thread to be audibly rendered via speaker(s) of the client device 510 (e.g., one example of a non-generative action). For instance, the text included in the email thread can be audibly rendered for presentation to the user. Accordingly, even though the first suggestion 554A2 and the second suggestion 554A3 may be static suggestions, the content that is provided in response to receiving a selection of these suggestions will vary based on the content that is displayed at the client device 510. Similar to FIGS. 5A and 5B, one or more other suggestions that are determined may be considered dynamic suggestions in that they are specifically tailored to the content that is displayed at the client device 510.

For example, and referring specifically to FIG. 5D, assume that the user in FIG. 5C horizontally swiped along the carousel of suggestions to reveal some of the other suggestions. For instance, and as shown in FIG. 5D, a third suggestion 554D1 and a fourth suggestion 554D2 are illustrated. The third suggestion 554D1 can be associated with generating a formal reply for the example reply email displayed at the client device 510 of the user and, when selected, will cause the reply to be generated and using a formal tone, vocabulary, etc. (e.g., a generative action). For instance, the GM model can be utilized to determine, based on the content of the email thread, a reply email that utilizes the formal tone, vocabulary, etc. Further, the fourth suggestion 554D2 can be associated with generating a casual reply for the example reply email displayed at the client device 510 of the user and, when selected, will cause the reply to be generated and using a casual tone, vocabulary, etc. (e.g., a generative action). For instance, the GM model can be utilized to determine, based on the content of the email thread, a reply email that utilizes the casual tone, vocabulary, etc.

Although the examples of FIGS. 5A-5D are described with respect to functionality of certain suggestions that are visually rendered at the client device 510 and based on the displayed content that is based on the content displayed at the client device 510 of the user, it should be understood that is for the sake of example and is not meant to be limiting. For instance, and referring specifically to FIG. 5E, assume that, in lieu of receiving a user selection of any suggestions, that the user provides free-form natural language input 560 of “Generate an image of a puppy with a human smile” via typed input or spoken input. In this example, the corresponding action to be performed is a generative action associated with generating an image of a puppy that includes a human mouth that is smiling. Accordingly, and referring specifically to FIG. 5F, a generative image of a puppy with a human smile can be visually rendered at the generative content graphical card 580 and as indicated by 562.

Notably, and as indicated by the hand 501 of the user of the client device 510, the use can drag the generative image from the generative content graphical card 580 to a portion of the display 522 of the client device 510 that includes the example reply email as indicated at 558. Accordingly, techniques described herein enable quick and efficient techniques to interact with GM(s) and without having to navigate to separate software application(s), separate tabs in a web browser application, etc., and without having to copy or paste generative content to cause it to be provided to other software applications. Rather, the user can simply drag and drop the generative content (e.g., a generative image in the example of FIGS. 5E and 5F, but other generative content as well such as generative text, generative video, generative audio, etc.) to cause the underlying tab and/or software application to include the generative content.

In various implementations, the user providing the free-form natural language input 560 via typed input or spoken input, the generative image being visually rendered, and/or the user dragging and dropping the generative content to the underlying web browser and/or software application can cause the plurality of suggestions to be updated and based on a change in the content that is displayed at the client device 510.

For example, and still referring to FIG. 5F, subsequent to the generative image being generated and visually rendered via the generative content graphical card 580, an updated third suggestion 554F1 and an updated fourth suggestion 554F2 are now illustrated (e.g., in lieu of the third suggestion 554D1 and the fourth suggestion 554D2 from FIGS. 5D and 5E). The updated third suggestion 554F1 can be associated with saving the image locally at the client device 510 and/or via a cloud-based storage system (e.g., a non-generative action). For instance, the generative image indicated at 562 can be saved to a photo/video album associated with the user of the client device 510. Further, the updated fourth suggestion 554F2 can be associated with attaching the generative image indicated at 562 and sending a message along with the generative image to one or more recipients (e.g., a generative action). For instance, the GM model can be utilized to determine, based on generative image indicated at 562, a reply email and/or an unrelated electronic communication or social media post (e.g., that is in addition to the reply email, such as a text message along with text of “look how cute this puppy is!”), which can then be sent to one or more recipient users.

Although certain examples are described with respect to FIGS. 5A-5F, it should be understood that those examples are included for the sake of illustrating various techniques contemplated herein and are not meant to be limiting. Rather, it should be understood that the generative content graphical card 580 described herein and the plurality of suggestions described herein that can be visually rendered along with the generative content graphical card 580 can vary based on the content that is being displayed at the client device 510 and based on how the user of the client device 510 interacts with the generative content graphical card 580.

Turning now to FIG. 6, a block diagram of an example computing device 610 that may optionally be utilized to perform one or more aspects of techniques described herein is depicted. In some implementations, one or more of a client device, multi-modal response system component(s) or other cloud-based software application component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIGS. 1 and 2.

These software modules are generally executed by processor 614 alone or in combination with other processors. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided and includes: receiving an invocation of a generative content graphical card at a client device of a user; in response to receiving the invocation of the generative content graphical card: causing the generative content graphical card to be visually rendered at the client device, the generative content graphical card overlaying content displayed at the client device via a display of the client device; processing, using a generative model (GM), GM input to generate GM output, the GM input including at least displayed content that is based on the content displayed at the client device; determining, based on the GM output, a plurality of suggestions to be visually rendered at the client device and responsive to the generative content graphical card, each of the plurality of suggestions being associated with a corresponding action that is performable with respect to the content displayed at the client device; and causing the plurality of suggestions to be visually rendered at the client device; and in response to receiving a user selection of a given suggestion, from among the plurality of suggestions, at the client device: causing the corresponding action, that is associated with the given suggestion from the user selection, to be performed; and causing a result of performance of the corresponding action to be visually rendered at the client device.

These and other implementations of technology disclosed herein can optionally include one or more of the following features.

In various implementations, the method may further include, prior to processing the GM input to the generate GM output: causing a selectable element to be visually rendered along with the generative content graphical card that, when selected, causes at least the displayed content, that is included in the GM input, to be stored in on-device memory of the client device; and in response to receiving a user confirmation via the selectable element: processing, using the GM, the GM input to generate the GM output.

In other implementations, at least the displayed content, that is included in the GM input, may be automatically stored in on-device memory of the client device in response to receiving the invocation of the generative content graphical card, and processing the GM input to generate the GM output using the GM may be in response to receiving the invocation of the generative content graphical card.

In various implementations, the corresponding action, that is associated with the given suggestion from the user selection, may be a generative action that utilizes the GM or an additional GM in causing the corresponding action to be performed.

In some versions of those implementations, causing the corresponding action to be performed may include: obtaining the displayed content from the on-device memory of the client device; processing, using the GM, additional GM input to generate additional GM output, the additional GM input including at least the displayed content and an indication of the corresponding action to be performed; and determining, based on the additional GM output, the result of the performance of the corresponding action.

In other versions of those implementations, causing the corresponding action to be performed may include: obtaining the displayed content from the on-device memory of the client device; transmitting, to a remote system, the displayed content and an indication of the corresponding action to be performed; and receiving, from the remote system, the result of the performance of the corresponding action. Transmitting the displayed content and an indication of the corresponding action to be performed to the remote system may cause the remote system to: process, using the additional GM, additional GM input to generate additional GM output, the additional GM input including at least the displayed content and an indication of the corresponding action to be performed; and determine, based on the additional GM output, the result of the performance of the corresponding action.

In various versions of those implementations, the GM may be an on-device GM that is stored locally at the client device, and the additional GM may be a cloud-based GM that is remote from the client device.

In various additional or alternative versions of those implementations, the method may further include, prior to causing the corresponding action to be performed: determining, based on one or more criteria, whether to utilize the GM or the additional GM in causing the corresponding action to be performed.

In some further additional or alternative versions of those implementations, the one or more criteria may include one or more of: whether the GM is capable of causing the corresponding action to be performed, whether the additional GM is capable of causing the corresponding action to be performed, whether the GM output specifies the GM or the additional GM should be utilized in causing the corresponding action to be performed, whether the client device has at least a threshold state of charge, weather a threshold quantity of computational resources are available at the client device to cause the corresponding action to be performed, a network connection status of the client device, hardware constraints of the client device, or software constraints of the client device.

In various additional or alternative versions of those implementations, the method may further include: determining, based on the GM output, one or more corresponding action parameters for each of the corresponding actions. The additional GM input may further include the one or more corresponding action parameters for the corresponding action to be performed.

In various other additional or alternative versions of those implementations, in response to receiving the user selection of the given suggestion, the method may further include: obtaining, for the corresponding action to be performed, one or more corresponding action parameters from the on-device memory of the client device. The additional GM further input may include the one or more corresponding action parameters for the corresponding action to be performed.

In various additional or alternative further versions of those implementations, one or more of the corresponding action parameters may include one or more of: a description of one or more software applications that are accessible by the client device and that are associated with the corresponding action to be performed, or a description of one or more application programming interface (API) calls that are makeable by the client device and that are associated with the corresponding action to be performed.

In various implementations, the corresponding action, that is associated with the given suggestion from the user selection, may be a non-generative action that does not utilize the GM or any other GM in causing the corresponding action to be performed.

In various implementations, the GM may be an on-device GM that is stored locally at the client device.

In various implementations, causing the plurality of suggestions to be visually rendered at the client device may include: causing an indication of the corresponding action that is performable with respect to the content displayed at the client device to be visually rendered at the client device.

In various implementations, causing the plurality of suggestions to be visually rendered at the client device may include: causing the plurality of suggestions to be visually rendered as a carousel of suggestions along with the generative content graphical card.

In various versions of those implementations, implementations the carousel of suggestions may be visually rendered above the generative content graphical card.

In various additional or alternative versions of those implementations, the carousel of suggestions, when initially visually rendered at the client device, only displays a subset of suggestions, from among the plurality of suggestions, and wherein the carousel of suggestions enables the user to swipe along the display of the client device to reveal additional suggestions, from among the plurality of suggestions.

In various additional or alternative versions of these implementations, a quantity of suggestions, included in the subset of suggestions, may be based on a display size of the display of the client device and/or an orientation of the client device.

In various implementations, a quantity of the plurality of suggestions may be based on a display size of the display of the client device and/or an orientation of the client device.

In various implementations, receiving the invocation of the generative content graphical card at the client device may include: receiving audio data that captures a spoken utterance of the user, the audio data being generated by one or more microphones of the client device; and determining that the spoken utterance includes a particular word or phrase that, when detected, invokes the generative content graphical card at the client device.

In various implementations, receiving the invocation of the generative content graphical card at the client device may include: determining that a hardware button of the client device has been actuated that, when actuated, invokes the generative content graphical card at the client device.

In various implementations, the plurality of suggestions may include one or more static suggestions that are not specific to the content displayed at the client device, and the plurality of suggestions may further include one or more dynamic suggestions that are specific to the content displayed at the client device.

In some versions of those implementations, the one or more static suggestions that are not specific to the content displayed at the client device may be visually rendered while the GM input is being processed by the GM to generate the GM output.

In additional or alternative versions of those implementations, the one or more dynamic suggestions that are specific to the content displayed at the client device may be visually rendered asynchronously with respect to the one or more static suggestions that are not specific to the content displayed at the client device.

In various implementations, the generative content graphical card may further include a free-form natural language input field that is in addition to the plurality of suggestions.

In some versions of those implementations, the method may further include, in response to receiving free-form natural language input from the user via the free-form natural language input field: causing additional GM input to be processed, using the GM or an additional GM, to generate additional GM output, the additional GM input including at least the free-form natural language input; and determining, based on the additional GM output, responsive content that is responsive to the free-form natural language input.

In various implementations, content displayed at the client device may be associated with a document, and the generative content graphical card may further include a selectable element that, when selected, causes the document to be stored in on-device storage of the client device.

In some versions of those implementations, the GM input may further include the document, or additional content that is determined based on the document.

In additional or alternative versions of those implementations, causing the corresponding action to be performed may include: obtaining the document, or the additional content that is determined based on the document, from the on-device memory of the client device; processing, using the GM, additional GM input to generate additional GM output, the GM input including at least the additional content that is determined based on the document, from the on-device memory of the client device and an indication of the corresponding action to be performed; and determining, based on the additional GM output, the result of the performance of the corresponding action.

In various implementations, the content displayed at the client device may be first-party (1P) content, the GM input may further include additional data associated with the displayed content, and the 1P content may be associated with a 1P entity that develops and/or maintains the GM.

In various other implementations, the content displayed at the client device may be third-party (3P) content, the GM input may only include the displayed content without any additional data that is associated with the displayed content, and the 3P content may be associated with a 3P entity is distinct from a first-party (1P) entity that develops and/or maintains the GM.

In various implementations, the result of the performance of the corresponding action may be draggable and droppable, based on a touch gesture received from the user, from the generative content graphical card overlaying the content displayed at the client device and to the content displayed at the client device.

In various implementations, the result of the performance of the corresponding action may be shareable, based on a touch gesture received from the user, between the client device and one or more additional client devices.

In various implementations, the result of the performance of the corresponding action may be savable, based on a touch gesture received from the user, to on-device memory of the client device.

In various implementations, the displayed content that is based on the content displayed at the client device may be one or more of: a screenshot of the content displayed at the client device, optical character recognition (OCR) results of a screenshot of the content displayed at the client device, or image recognition results for a screenshot of the content displayed at the client device.

In various implementations, the GM input further may include one or more of: a quantity of the plurality of suggestions, a schema for each of the plurality of suggestions, a maximum length for each of the plurality of suggestions, or a zero-shot example for utilization in generating the GM output.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods. Some implementations also include a computer program product including instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
receiving an invocation of a generative content graphical card at a client device of a user;
in response to receiving the invocation of the generative content graphical card:
causing the generative content graphical card to be visually rendered at the client device, the generative content graphical card overlaying content displayed at the client device via a display of the client device;
processing, using a generative model (GM), GM input to generate GM output, the GM input including at least displayed content that is based on the content displayed at the client device;
determining, based on the GM output, a plurality of suggestions to be visually rendered at the client device and responsive to the generative content graphical card, each of the plurality of suggestions being associated with a corresponding action that is performable with respect to the content displayed at the client device; and
causing the plurality of suggestions to be visually rendered at the client device; and
in response to receiving a user selection of a given suggestion, from among the plurality of suggestions, at the client device:
causing the corresponding action, that is associated with the given suggestion from the user selection, to be performed; and
causing a result of performance of the corresponding action to be visually rendered at the client device.

2. The method of claim 1, further comprising:
prior to processing the GM input to the generate GM output:
causing a selectable element to be visually rendered along with the generative content graphical card that, when selected, causes at least the displayed content, that is included in the GM input, to be stored in on-device memory of the client device; and
in response to receiving a user confirmation via the selectable element:
processing, using the GM, the GM input to generate the GM output.

3. The method of claim 1, wherein at least the displayed content, that is included in the GM input, is automatically stored in on-device memory of the client device in response to receiving the invocation of the generative content graphical card, and wherein processing the GM input to generate the GM output using the GM is in response to receiving the invocation of the generative content graphical card.

4. The method of claim 2, wherein the corresponding action, that is associated with the given suggestion from the user selection, is a generative action that utilizes the GM or an additional GM in causing the corresponding action to be performed.

5. The method of claim 4, wherein causing the corresponding action to be performed comprises:
obtaining the displayed content from the on-device memory of the client device;
processing, using the GM, additional GM input to generate additional GM output, the additional GM input including at least the displayed content and an indication of the corresponding action to be performed; and
determining, based on the additional GM output, the result of the performance of the corresponding action.

6. The method of claim 4, wherein causing the corresponding action to be performed comprises:
obtaining the displayed content from the on-device memory of the client device;
transmitting, to a remote system, the displayed content and an indication of the corresponding action to be performed, wherein transmitting the displayed content and an indication of the corresponding action to be performed to the remote system causes the remote system to:
process, using the additional GM, additional GM input to generate additional GM output, the additional GM input including at least the displayed content and an indication of the corresponding action to be performed; and
determine, based on the additional GM output, the result of the performance of the corresponding action; and
receiving, from the remote system, the result of the performance of the corresponding action.

7. The method of claim 4, wherein the GM is an on-device GM that is stored locally at the client device, and wherein the additional GM is a cloud-based GM that is remote from the client device.

8. The method of claim 4, further comprising:
prior to causing the corresponding action to be performed:
determining, based on one or more criteria, whether to utilize the GM or the additional GM in causing the corresponding action to be performed.

9. The method of claim 8, wherein the one or more criteria comprise one or more of: whether the GM is capable of causing the corresponding action to be performed, whether the additional GM is capable of causing the corresponding action to be performed, whether the GM output specifies the GM or the additional GM should be utilized in causing the corresponding action to be performed, whether the client device has at least a threshold state of charge, weather a threshold quantity of computational resources are available at the client device to cause the corresponding action to be performed, a network connection status of the client device, hardware constraints of the client device, or software constraints of the client device.

10. The method of claim 4, further comprising:
determining, based on the GM output, one or more corresponding action parameters for each of the corresponding actions, wherein the additional GM input further includes the one or more corresponding action parameters for the corresponding action to be performed.

11. The method of claim 4, in response to receiving the user selection of the given suggestion, further comprising:
obtaining, for the corresponding action to be performed, one or more corresponding action parameters from the on-device memory of the client device, wherein the additional GM further input includes the one or more corresponding action parameters for the corresponding action to be performed.

12. The method of claim 10, wherein one or more of the corresponding action parameters comprise one or more of: a description of one or more software applications that are accessible by the client device and that are associated with the corresponding action to be performed, or a description of one or more application programming interface (API) calls that are makeable by the client device and that are associated with the corresponding action to be performed.

13. The method of claim 1, wherein the corresponding action, that is associated with the given suggestion from the user selection, is a non-generative action that does not utilize the GM or any other GM in causing the corresponding action to be performed.

14. The method of claim 1, wherein the GM is an on-device GM that is stored locally at the client device.

15. The method of claim 1, wherein causing the plurality of suggestions to be visually rendered at the client device comprises:
causing an indication of the corresponding action that is performable with respect to the content displayed at the client device to be visually rendered at the client device.

16. The method of claim 1, wherein causing the plurality of suggestions to be visually rendered at the client device comprises:
causing the plurality of suggestions to be visually rendered as a carousel of suggestions along with the generative content graphical card.

17. The method of claim 16, wherein the carousel of suggestions are visually rendered above the generative content graphical card.

18. The method of claim 16, wherein the carousel of suggestions, when initially visually rendered at the client device, only displays a subset of suggestions, from among the plurality of suggestions, and wherein the carousel of suggestions enables the user to swipe along the display of the client device to reveal additional suggestions, from among the plurality of suggestions.

19. A system comprising:
at least one processor; and
memory storing instructions that, when executed by the at least one processor, cause the at least one processor to be operable to:
receive an invocation of a generative content graphical card at a client device of a user;
in response to receiving the invocation of the generative content graphical card:
cause the generative content graphical card to be visually rendered at the client device, the generative content graphical card overlaying content displayed at the client device via a display of the client device;
process, using a generative model (GM), GM input to generate GM output, the GM input including at least displayed content that is based on the content displayed at the client device;
determine, based on the GM output, a plurality of suggestions to be visually rendered at the client device and responsive to the generative content graphical card, each of the plurality of suggestions being associated with a corresponding action that is performable with respect to the content displayed at the client device; and
cause the plurality of suggestions to be visually rendered at the client device; and
in response to receiving a user selection of a given suggestion, from among the plurality of suggestions, at the client device:
cause the corresponding action, that is associated with the given suggestion from the user selection, to be performed; and
cause a result of performance of the corresponding action to be visually rendered at the client device.

20. A non-transitory computer-readable storage medium storing instructions that, when executed by at least one processor, cause the at least one processor to:
receive an invocation of a generative content graphical card at a client device of a user;
in response to receiving the invocation of the generative content graphical card:
cause the generative content graphical card to be visually rendered at the client device, the generative content graphical card overlaying content displayed at the client device via a display of the client device;
process, using a generative model (GM), GM input to generate GM output, the GM input including at least displayed content that is based on the content displayed at the client device;
determine, based on the GM output, a plurality of suggestions to be visually rendered at the client device and responsive to the generative content graphical card, each of the plurality of suggestions being associated with a corresponding action that is performable with respect to the content displayed at the client device; and
cause the plurality of suggestions to be visually rendered at the client device; and
in response to receiving a user selection of a given suggestion, from among the plurality of suggestions, at the client device:
cause the corresponding action, that is associated with the given suggestion from the user selection, to be performed; and
cause a result of performance of the corresponding action to be visually rendered at the client device.
